(19) United States
(12) Patent Application Publication
(10) Pub. No.: US 2018/0263234 A1
(43) Pub. Date: Sep. 20, 2018

(54) INSECT CONTROL DEVICE AND METHOD OF USING THE SAME

(71) Applicant: IPM PRODUCTS MANUFACTURING, INC., Denver, CO (US)

(72) Inventors: Randy J. SASAKI, Centennial, CO (US); Thomas BROWN, Tempe, AZ (US); Alexandra Elyse HARTMAN, Tolleson, AZ (US)

(73) Assignee: IPM PRODUCTS MANUFACTURING, INC., Denver, CO (US)

(21) Appl. No.: 15/762,236

(22) PCT Filed: Sep. 27, 2016
(86) PCT No.: PCT/US2016/053907

§ 371 Date: Mar. 22, 2018

Related U.S. Application Data
(60) Provisional application No. 62/236,046, filed on Oct. 1, 2015.
(60) Provisional application No. 62/276,010, filed on Jan. 7, 2016.

(51) Int. Cl. A01M 1/22; A01M 1/04; H02S 40/32

(52) U.S. Cl. CPC A01M 1/223; H02S 40/38; H02S 40/32; A01M 1/04

(57) ABSTRACT

An environmentally friendly method and device to eliminate insect pests utilizing lighting, sound, pheromones or scents, alone or in combination. This present invention to remove pests avoids the expense of biocide technologies that have not been developed fully, the damage to people and the environment from the use of dangerous chemical pesticides, and add to sustainable agriculture efforts including integrated pest management.

### CROSS REFERENCE TO RELATED APPLICATIONS

This application claims the benefit of U.S. Provisional Patent Application No. 62/236,046, filed Oct. 1, 2015, and U.S. Provisional Patent Application No. 62/276,010, filed on Jan. 7, 2016. Each of these applications are hereby incorporated by reference in their entirety.

### FIELD OF THE INVENTION

The present invention is directed to a method of reducing insect pests from agriculture, livestock, and human interaction without adversely affecting the environment. The system attracts insects to a location where they can be safely eliminated. A primary aspect of the present invention is to attract the insects with a light source, for example electroluminescent (EL) lighting. Other types of lighting and sensory attractants for insects are also described and can be used in various combinations. The reduction of pests can be accomplished by attractive elimination such as by a high voltage grid or other known methods.

### BACKGROUND

Problems arise with the introduction of insect pests in artificially created agroecosystems used to satisfy the demands for suitable crops for human consumption. These agroecosystems create a highly conducive environment for herbivorous insects, which are responsible for destroying one fifth of the world's total crop production annually. Insects harm crops by feeding directly on the plants, transmitting plant diseases, and even post harvesting when the harvested crop has been stored for distribution. Current solutions involve sustainable agriculture techniques, biotechnology, and pesticides.

Pesticides have been used to increase crop yield per acre to meet the growing demand of the increasing worldwide population. Chemicals are introduced into the environment each year affecting wildlife, water quality, and air quality. Pesticides are absorbed into food and are prevalent in the fruits and vegetables meaning pesticides are regularly ingested by humans. Toxicity of pesticides varies from each product based upon its country of origin and the pesticide used. Studies have shown, for example, that pesticides may cause Parkinson's disease, an increased risk of cancer, miscarriages, damage to the central nervous system and kidney, and also act as endocrine disrupters. Pesticides can also cause birth defects in animals and humans. Symptoms from pesticide ingestion can take years to surface after your initial exposure. Pesticides also indiscriminately kill birds, bats, and other pest predators.

Currently, the amount of pesticide a farmer uses is limited by the sensitivity of the crop to the pesticide. To address this issue, researches in biotechnology are currently exploring genetically altered crops to create pesticide tolerant, insect resistant, and virus resistant crops. Pesticide resistant crops could help plants avoid the harmful effects and limitations of traditional pesticides. However, pesticide resistant crops could incentivize farmers to use larger volumes of the pesticide, which only perpetuates the problem of pesticide and its adverse toll on human and animal health and the environment.

Testing has also been conducted on genetically engineering crops to contain the insect-killing toxin from Bacillus thuringiensis (B.t.), a useful biocontrol agent. However, there is a high potential for accelerated evolution of pest resistance to B.t., which can result in the loss of one of agriculture's safest and most useful biocontrol agents currently produced. There are currently no manufactured virucides that do not also harm crops. The thought behind engineering virus resistance is that the plants can be engineered to contain a virus gene so the plant could resist attack by the same virus. In the short-term, this method could reduce losses due to viruses and reduce the use of insecticides. However, a long-term use issue is the ability of viruses to rapidly evolve, rendering the engineered plants susceptible to attack once again.

Biopesticides are an environmentally safe alternative to chemical pesticides. Biopesticides are agricultural biologicals which are made from materials found in nature to act as sustainable crop protection. Most biopesticides are only in the early development phases, and are not as effective as chemical pesticides.

Additionally, the very insecticides once used to maintain higher yields are now hurting crop production. Between 2005 to 2013, Colony Collapse Disorder emerged as a substantial worldwide issue. It is believed that thirty percent of the total bee colonies (in the United States) were dying off each year. Studies found that agricultural residue near collapsed bee colonies contained 700,000 times the lethal level of neonicotinoid pesticides for bees. Numerous studies during this time have implicated pesticides as a factor in Colony Collapse Disorder. As a result, there are not enough bees to pollinate the existing crops, which is essential for sustainable crop growth. Without the bees to pollinate the crops, the amount of pesticides used to mitigate pests in crops becomes irrelevant. In 2013, a mass die-off of bees took place in Wilsonville, Oreg. 25,000 bees were killed simultaneously as a result of misuse of a neonicotinoid pesticide (Medical Daily, Bee Kill-Off in Oregon: Officials Confirm Bee Deaths Result of Insecticide ‘Safari’, http://www.medicaldaily.com/bee-kill-oregon-officials-confirm-bee-deaths-result-insecticide-safari-247051 (last viewed Sep. 21, 2016)) on surrounding trees. As a result of Colony Collapse Disorder, the European Union voted to ban neonicotinoid pesticides for a two-year period, and instead use sustainable agriculture techniques, biotechnology, and pesticides.

Sustainable agriculture techniques may not be sufficient. A farm is its own ecosystem and harboring populations of pest predators can be an effective pest-control technique. Sustainable agriculture techniques are a means to avoiding harmful pesticides by practicing crop rotation, soil enrichment, and utilizing natural pest predators. Crop rotation breaks the pest reproductive cycles by growing different crops in succession in the same field. Continuously growing the same crop guarantees a steady food supply and thereby a steady or increasing pest population because many pests have preferences for specific crops. This technique does not guarantee the removal of pests, and is only a partial solution. Neighboring farm schedules could allow pests to cycle through other surrounding farms and back to their original location. Soil enrichment can be achieved by plowing under crop residues in the field after harvest, covering crops, or adding composted plant material or animal manure. Healthy soil improves yields and produces robust crops that are less vulnerable, though not impervious, to pest invasions. Other variables, such as the drought, can also reduce pest predator populations, but are unpredictable.

A pest control system and method are needed to attract insect pests away from crops, livestock, and humans, without harming the environment or individuals.

### SUMMARY

There are two different methods for reducing the insect population: attractive elimination and dispersed elimination. Attractive elimination is the process of eradicating insect pests via luring the insects into a trap. In this case, trap has a broad definition that encompasses electronic flying insect killers, electrocution grids, light traps, adhesive traps, flying insect airflow traps, and terrestrial and aquatic arthropod traps. Dispersed elimination is the application of insecticides to eliminate insect pests over a broad area.

A flower attracts insects in three different ways. The first attractant is the scent of the flower, encouraging insects to find and pollinate the blossom. The scent acts as an attractant at large distances. The second attractant is the color of the bloom. The color of the bloom appeals to insects at a mid-ranged level. The third attractant is the brightly colored inner section of the flower, called a pistil. The pistil entices insects at a very close range. The present invention mimics these characteristics, individually, or in combination.

The three attractants can be used cohesively with an electroluminescent light panel. The area of the light panel can vary. An array of LEDs can be used as an electroluminescence source, for example. The color of the light panel by itself can cover the middle range of insect attraction with respect to distance and can be used unaided. LEDs of the same or different color can be used for spot lighting to accelerate the speed of insect attraction at short-range distances. Additional options include the use of pheromones that can encompass a wider scope of attraction. Further still, aspects of the present disclosure can include a fourth attractant. The sound that the inverter and/or the EL light source emit is an attractant to insects due to the disruptive vibrations in the surrounding environment. An EL is any light source that is generated directly by an electrical source without going through heat or plasma stage. This includes light emitting diode (LED), organic light emitting diode (OLED) and other types of EL. By way of example only, an EL can be phosphor between two plates of a capacitor that is excited and gives off light when an AC voltage is applied across the capacitor. At least one side of the capacitor plate is transparent, allowing the light to exit. In addition, an artificial noise source can be utilized that offers an output having an adjustable wavelength. These elements can be used either together or individually as well as in any combination.

Two primary categories of scents are those associated with food and reproduction to entice insects to a trap. Scents associated with food for a mosquito include carbon dioxide, and materials found in animal sweat such as nonanal, lactic acid, octanol, and low molecular weight carboxylic acids. Pheromones can be used to attract insects by using scents that are associated with reproduction. These scents can be mixed with polymers and cured to form a matrix of material that will attract insects. The polymers used can include UV or heat cured polyurethanes, acrylics, and vinyl. These scent/polymer mixtures can be placed on EL lamps or other warming elements where the heat can help to volatilize and transmit these scents into the air. For scents that mimic food, concentrations from about 0.01 wt. % to about 30 wt. % can be used. Using concentrations from about 0.1 wt. % to about 20 wt. % to attract insects can be more beneficial. For pheromones, the concentration can be lower and more commonly between about 0.001 wt. % and about 5 wt. %, with target ranges between 0.01 wt. % and about 2 wt. %, with 0.01% being more beneficial.

Semiochemicals, or pheromones, can be used to manipulate the behavior of insect pests. They are non-toxic and biodegradable chemicals that lure insects into traps, or cause them to expend energy they normally require for locating food and mates. Insects detect the pheromones by antennae. Some pheromones can be active for days and act as territorial boundaries. Semiochemicals can also be used to convey warnings of danger and reproductive readiness. Using pheromones to indicate reproductive readiness equates to distracting the males away from females to reduce the population density of pests by minimizing interaction and, accordingly, how much they reproduce. In each of these circumstances, the pheromones either act to lure insects to their extermination or to repulse them from an area. According to aspects of the present disclosure, pheromones targeted at attracting insects would be used in order to lure them towards their neutralization. This includes combinations of semiochemicals that can be incorporated into polymers and screen printed onto the attractive panel. It also includes the use of heaters including self-limiting heaters that can increase the vapor pressure of the pheromones by gently heating a polymer matrix incorporated with the heater.

Some insects respond to sound. Mosquitos have well developed organs for hearing. Their feathery antennae are attached to the Johnston's organ for hearing. They are sensitive to sounds up to 2000 Hz. Mosquitos use sound to identify mates and are attracted to certain frequencies of sound. The frequency for use with the present invention can be determined by the exact mosquito species and type, the sex of the mosquito, and the air temperature. The frequency can be based on insect activity. The disclosed device uses the frequency hopping technique to attract a range of mosquito species and is effective at various air temperatures. Frequencies from 100 Hz to 1200 Hz can be used but a narrow range of 350 Hz to 550 Hz can be more focused to get the desired results. Frequency hopping can be done at different intervals for example 25 Hz steps for 5 to 600 seconds at each step or the steps can be proportional for example like musical notes from F4 (349.23 Hz) to C#5 (554.37 Hz). Mosquitos change their wing flapping frequency to become in tune to a mate as they come into the area where the sound is emanating. As the frequency of the output changes it can imitate the changing frequency during mating. The tones used can be random or sequential. The sonic attraction can be used by itself or in conjunction with light and/or scents to attract insects. The sonic attracting element can be generated with a speaker, a piezo element or from a deposited layer of dielectric material. The dielectric layer can be part of an EL light. The deposition method can be screen printing or similar printing techniques such as roll coating, slot coating, stencil coating, or several other methods known in the art.

The sound attractant component can attract insects due to the vibration released to the surrounding environment. As the decibels increase, so does the effective area that reaches insects. Additionally, insects prefer frequencies anywhere from about 100 to 400 Hertz. The inverter used to convert the solar power for use in the lamp and the lamps themselves emits a sound around 80 decibels at 350 Hertz. The frequency of this sound can be adjusted to attract different pests. While this frequency might not work for long range attraction, it can assist in the short range attraction of the insect pests to the device.

Mosquitoes, crickets, moths, cockroaches, and fruit flies exhibit some phonotaxis and are susceptible to trapping via sound enticement. Sound enticement can be used to mimic mate-seeking adults and can be used to produce signals that disrupt vibrational communication between insects. While mosquitos are not highly susceptible to phonotaxis, they can be drawn to the general area of light. An EL lamp or other light source such as a fluorescent light or mercury discharge lamp is designed to attract insects over a broad area to where they can hear the sounds being produced in the trap.

Light traps, with or without ultraviolet (UV) light, attract certain insects. UV lights are the technology currently employed in many bug zappers. The long wave UV-A is very attractive to insects and does not contain much visible light. This electromagnetic radiation falls in a wavelength from 320 nanometers to 400 nanometers. Insects perceive light in the 300 to 650 nanometer range, but prefer light that is between 300 to 480 nanometers. The UV light can be used in conjunction with the main operation panel, which can be designed to operate in the range of 300 to 650 nanometer. This present invention is so effective in attracting insects because it can operate at about the 480 nanometer range of light, which is a known attractive color to compound eyed insects. A 15-acre area requires drawing insects from about 456 feet away (i.e. radius). Additional wavelengths of light can be easily added to this panel for specific insects as required.

The lamp is designed to attract insects over an area, up to about 15-acre. The product primarily uses a high voltage grid to kill the attracted insect. Insects have compound eyes, meaning they only have two types of color pigment receptors sensitive to 3 colors of light: ultraviolet, blue, and green. Bright white or bluish lights (blue or green EL, mercury vapor, white incandescent, and white fluorescent) are the most attractive to insects. Yellowish, pinkish, or orange (sodium vapor, halogen, or dichrom yellow) are the least attractive to most insects. Additional wavelengths of light can be easily added to the panel for specific insects as required.

According to aspects of the present disclosure, the main panel is an electroluminescent lamp that can exhibit Lambertian emission, which means that the surface of the lamp has the same radiance when viewed from any angle. This surface can be beneficial as a light source for attracting insects where the panel could be viewed at long distances and from many different angles. A single panel could attract insects over a large area.

Another advantage of the invention is that the light source would not affect the beneficial pollination insects that are active during the day, but rather would attract the insect pests that lay eggs or reproduce during the night. Additionally, this device can be powered using alternative energy, such as solar energy, wind power, hydropower, and the like, in addition to traditional electricity, coal and natural gas sources. The system can operate continuously independent of electrical input keeping with the technology's green initiative.

An aspect of the invention is an insect control system. The system includes an electroluminescent light source that acts as a Lambertian emitter, and at least one electrical grid located within an operation panel.

An aspect of the invention is an insect electrocution system. The system includes a solar panel, at least one power storage device, at least one of an electrocution grid and insect trap, and an operational panel. The power storage device stores energy from the solar panel. The operational panel includes at least two of the following insect attracting elements: a first electroluminescent light source that is a Lambertian emitter, a second electroluminescent light source that operates at a different wavelength than the first electroluminescent light source, at least one of the first and second electroluminescent light source pulses, at least one sound source, and at least one scent source. The power storage device provides power for the at least two attracting systems, and the electrocution grid.

An aspect of the invention is a method to execute non-pollinating insects. The method includes providing a system to an area. The system includes at least one light emitting source, and an electrocution grid within an operation panel. The light emitting source attracts non-pollinating insect to the system, and the electrical grid electrocutes the non-pollinating insect once it is attracted to the system.

### BRIEF DESCRIPTION OF THE DRAWINGS

The present invention is not limited in its application to the particular schematics shown. The invention is capable of alternate embodiments, and all terminology is for the purpose of the description.

FIG. 1 illustrates a schematic diagram of one embodiment of the present disclosure;

FIG. 2 illustrates a schematic diagram of panel components according to aspects of the present disclosure;

FIG. 3 illustrates a block diagram of electrical control components of one embodiment of the present disclosure;

FIG. 4 illustrates a schematic diagram of the layers of an electroluminescent light source according to aspects the present disclosure;

FIG. 5 illustrates a block diagram of the electronics of an insect control device according to aspects of the present disclosure;

FIG. 6 depicts an embodiment of an insect control device according to aspects of the present disclosure;

FIG. 7 depicts an embodiment of an insect control device according to aspects of the present disclosure;

FIG. 8 illustrates an embodiment of the box before components are added to the box; and

FIG. 9 illustrates an embodiment of the operational panel.

### DETAILED DESCRIPTION

The present disclosure is directed to an insect control system. The system includes at least one light source that acts as a Lambertian emitter, and at least one electrical grid located within an operation panel.

The light source can emit light in a wavelength between 250 nm and 650 nm. The light source can be fluorescent, luminescent light, or a LED, including an OLED, and combinations thereof. In some embodiments, multiple light sources can be used, which can emit the same or different wavelengths of light. Different wavelengths can be more or less attractive to insects. The light source can be emitted as at least one spot, dot, strip, panel, triangle, oval, rectangle or any other suitable and/or desired shape. The light source can also be a plurality of light sources or can emit at least two wavelengths of light. The light can be from a Lambertian emitter. The lights can emit light at wavelengths between about 250 nm and about 800 nm, in some embodiments about 300 to 650 nanometer, in some embodiments between 350 to 480 nanometers. In some embodiments, the light source can be an electroluminescent light that can be blue in color and in the range of 400 nm to 480 nm. In some embodiments, the light source can be a LED light, which can be green in color and about 525 nm. In some embodiments, the light source (electroluminescent or otherwise) can pulse. In embodiments where multiple light sources are used, each light source can pulse at the same frequency or at different frequencies. The frequency of the pulse can be between about 100 Hz and about 2000 Hz. In some embodiments, the frequency of the pulse can be between about 100 Hz and about 600 Hz, about 350 Hz to about 550 Hz, about 100 Hz to about 1000 Hz, or between about 100 Hz and about 1500 Hz. In some embodiments, the frequency can change from a first frequency to a second frequency, or to additional frequencies. The frequency can change by either scanning or by hopping. Scanning as used herewith means to change values in a consecutive or sequential order, either increasing or decreasing in value using a non-integer method for example the charging of a capacitor where there is a smooth transition from one frequency to another while hitting all the frequencies in between. For example, transitioning gradually from 350 Hz to 400 Hz while hitting all the frequencies in between. Hopping means to change from a first value to a second value in a digital move, where the first value and the second value are incrementally different and may or may not be consecutive. For example, a first value might be 350 Hz, and a second value might be 600 Hz, and a third value might be 400 Hz. Frequency hopping is more likely to be digital and programmed in nature and not relying on a physical process like charging a capacitor. In some embodiments, the light source can be chosen based on the time of day that the system will be used. By way of example, it can be beneficial to use an EL light during night time hours and a LED light during daytime hours. In some embodiments, the light source can also act as the sound generating device.

The electric grid can be made from an electrically conductive material. Suitable materials include stainless steel, silver, copper, gold, aluminum, titanium, similar materials, and combinations thereof. In some embodiments, the material can be 304 or 316 stainless steel. The electrical grid can be mesh cloth. The grid openings of the electrical grid can be any suitable size, including openings between about 0.1 and about 1.0 inches, in some embodiments about 0.25 inches to 0.5 inches. In some embodiments, the grid can be a number 2 grid (i.e. two grids per linear inch), a number 3 grid (i.e. three grids per linear inch), or a number 4 grid (i.e. four grids per linear inch). The size of the grids can be determined based on the size of the insects to be attracted by the system. In some embodiments, more than one grid can be used in the system. The grids can be the same size or different sizes. In some embodiments when more than one grid is used, the grids can be spaced such that the larger grid can be placed in front of the smaller grid (i.e. the larger grid is closer to the opening of the panel). The grids can be sized to allow light and scents to transmit through the grids. A spacer can be used to separate the materials. The spacer between the grids can be between about 0.1 inches and about 2 inches, in some embodiments about 0.25 inches and in some embodiments about 0.50 inches.

The system can further include an attraction sensory panel. The attraction sensory panel can include multiple sensory operations in a single device. The attraction sensory panel can include the light source. The attraction sensory panel can include a pheromone and/or scent. In some embodiments, the attraction sensory panel can further include at least one heater, for example a self-limiting heated strip, and at least one pheromone or scent. In an embodiment of the invention, at least one heater can be located adjacent to the light source. Pheromones or scents within the attraction sensory panel can be replaced as needed, for example on a semiannually or annual basis. The heated strip can be graphite based. Pheromones can be used to attract insects to the system for electrocution. The pheromones or scent can be selected to attract one or more specific insects. More than one pheromone can be used in the system to attract more than one insect. Suitable scents can include, but are not limited to, scents associated with food, including carbon dioxide, reproduction and egg laying, and combinations thereof. Scents that attract egg laying insects can include butyric acid and hexanoic acid. Scent associated with food may include materials found in animal sweat, including nonanal, lactic acid, butyric acid, hexanoic acid and other acids or esters with a molecular weight of less than 120, octanol, and low molecular weight carboxylic acids, and combinations thereof. For scents that mimic food concentrations between about 0.01% and about 30% can be used. Using concentrations from between 0.1% and about 20% to attract insects can be more beneficial. 0.001% and about 5%, with target ranges between 0.01% and about 2% to 0.01% being more beneficial. In some embodiments, a fan can be used to distribute the scent or pheromone. The attraction sensory panel can be polymeric material, for example an acrylic material. In some embodiments, the attraction sensory panel can include a fan and at least one switch for each scent or group of scents to turn additional scents on or off in the panel. Activation of the switch may be controlled by a processor, timer, light sensor or other methods know to those of skill in the art. In some embodiments, the attraction sensory panel can also include a separate power storage device or the battery for the system.

The pheromone and/or scent can be in a polymer matrix, silica gel or activated carbon or another porous carrier. The polymers used can include UV or heat cured polyurethanes, acrylics, and vinyl, inks and combinations thereof. The heater can heat the polymer matrix thereby enhancing the release of the pheromone and/or scent, which can be in the matrix. In some embodiments, multiple pheromones and/or scent can be used which can be activated in the attraction sensory panel at separate times to increase the release of a particular pheromone and/or scent, or simultaneously in the same or different quantities. In some embodiments, a computer program or programmable device can be used to activate or disable the heater. In some embodiments, the program or programmable device can control the heater and/or the pheromone release such that the scent from the pheromones or scents are released during predetermined times or for a predetermined duration. The predetermined time can be for any duration during a day, week, month, or year. The predetermined duration can be for between about 1 minute and about 24 hours. In some embodiments, the predetermined time can be for one hour, two hours, five hours, or ten hours. By way of example only, the attraction sensory panel can include pheromone A and scent B, each within a polymer matrix. The heater associated with pheromone A can be turned on to increase the release of pheromone A. The heater associated with scent B can remain off, thereby increasing the release of pheromone A compared to scent B. Alternatively, both heaters can be activated simultaneously and the temperature varied at each heater to produce a desired mixture of pheromone A and B. In some embodiments, a sonic device can be used to release the pheromones and/or scent by vibration. Suitable devices include, but are not limited to, a sonic with the integrated barium titanate dielectric array, piezoelectric speakers or coil driven speakers, or combinations thereof. The attraction sensory panel can be between about 4 inches and about 12 inches wide and about 6 inches to about 28 inches long, and, between about 0.1 and about 0.5 inches thick, in some embodiments the sensory panel is about 6 inches by about 18 inches about 0.25 inches thick. The attraction sensory panel can be a polymeric material. In some embodiments, the polymeric material can be acrylic composite. Other suitable materials can include polycarbonate or another stiff transparent plastic. In some embodiments, the polymer can by ultraviolet stabilized. These matrixes can be placed on EL lamps or other warming elements where the heat can help to volatilize and transmit these scents into the air.

The attraction sensory panel can be on a fixed panel in the device. In some embodiments, the attraction sensory panel can become the fixed panel once assembled into the operational panel. In some embodiments, the attraction sensory panel can be attached to a fixed panel in the operational panel. By way of example only, the light source and the attraction sensory panel can be on the back side of the system. In these embodiments, the light source and the attraction sensory panel can be oriented in any direction on the fixed panel. The electrical grid can be located in front of the fixed panel. The system can further include a frequency emitting device. The frequency emitting device can be used to produce sounds that can trap insects in the system by disrupting the vibrational communication between insects. The frequency can be between about 100 Hz and about 2000 Hz can be used but a narrow range of about 350 Hz to about 550 Hz can be more focused to get the desired results. Frequency hopping (as described above) can be done at different intervals for example 25 Hz steps for 5 to 600 seconds at each step or the steps can be proportional for example like musical notes from F4 (349.23 Hz) to C#5 (554.37 Hz). In some embodiments, the frequency can change by scanning. The amplitude can vary depending upon the foliage where the system is located. In some embodiments, the sound emitted can be calibrated to the insect to be terminated. The frequency emitting device can be the heated strip, the light source or another device in the system. In some embodiments, the components of the system can oscillate to create the emitting frequency. For example, the inverter of the system can generate a frequency.

The system, or components of the system, can be powered by an energy source. The energy source can be from at least one battery, solar energy, electricity, coal, water power, geothermal, natural gas, oil, or combinations thereof. In some embodiments, the energy source can be used to charge at least one battery associated with the panel for subsequent use.

A solar panel can be used to charge at least one battery for use by the system. The solar panel can have a wattage between about 1 W and about 100 W, in some embodiments about 20 W. The solar panel can produce between about 10 V and about 30 V, in some embodiments about 21 V. The solar panel can also produce between about 0.1 A and about 10 A, in some embodiments about 1 A. The dimensions of the solar panel can be between 6 inches and 36 inches, by between 10 inches and 24 inches, by between 13 inches and 20 inches. In some embodiments, the dimensions of the solar panel can be 20 inches by 13.37 inches by 1.375 inches thick. Suitable solar powered system includes, but are not limited to, systems produced by Infinium Solar, Sun Power, Kyocera, Ameresco Solar and combinations thereof. More than one solar panel can be used to achieve the required power to operate the system. Cables that attach the solar panel to the operation panel can be UV stabilized, and suitable for outdoor use. In some embodiments, the cables can be covered by a material to protect the cable from weather. By way of example only, the cables can be PVC coated copper wires. The wires can be between about 12 and about 24 AWG, in some embodiments about 16 AWG.

The system can include at least one power storage device, such as a battery. Multiple batteries can be joined in series or in parallel. Each battery can be rated for between about 3.7 and 24 V, in some embodiments about 12 V. When the batteries are powered in an inverter, they can create greater than about 2500 V. The inverter voltage may be increased by use of a boost inverter, a buck inverter or a voltage multiplier for example a capacitor and diode bridge. Each battery can be rated for between about 1 and 30 Amp-hours, in some embodiments about 9 Amp-hours. Each battery can operate at a temperature between about −40° C. and about 60° C. The battery can be weatherproof, or located in a weatherproof container. The weight of each battery can be between about 1 lb and about 5 lbs, in some embodiments about 2.8 lbs. The battery can be used to power components in the system, or components of the system, including a microprocessor which can control the light source, a boost inverter, and a voltage multiplier. A boost inverter can be used to convert direct current into alternating current. A boost inverter can build a magnetic field in an inductor, then turned off to stop current flow. A voltage pulse can be generated as the magnetic field collapses. A voltage multiplier can be used to power the electrical grid.

The attraction sensory panel, frequency emitting device, electronic components, power components, and electrical grid can be in an operation panel. In some embodiments, components, for example batteries, and the power supply, can be exterior to the operational panel. The operational panel can be a container, such as a box, that is open on one side. One side of the panel can be the fixed panel. The grids can be positioned over the attraction sensory panel and attach to the side panels of the operational panel. The operational panel can also include a protective panel on the open side of the operational panel over the grids. The protective panel can be sized according to the size of the operational panel. The protective panel can prevent animals, such as birds or humans from contacting the electrical grid. The length of the panel can be between about 6 inches and about 48 inches. The width of the panel can be between about 1 inch and about 12 inches, and the height of the panel can be between about 0.5 inches and about 48 inches. In some embodiments, the length of the panel can be about 18 inches, the width of the panel can be about 4 inches, and the height of a panel can be about 6 inches. Suitable materials for the operational panel can include any non-corrosive material, including but not limited to stainless steel, coated aluminum, titanium, aluminum alloys, and combinations thereof. In some embodiments, the material of the operational panel can be 304 stainless steel.

The system can further comprise a control manager. The control manager of the system can manage the charge control of power from the solar panel to the battery. The control manager can also include a short circuit protection. The short circuit protection can determine if there is a short in the panel, for example, a short caused by weather. If a short has been found, then the short circuit protection can determine if the short has cleared. For example, the short circuit protection can determine if the short has cleared after a time of between 30 seconds and about 5 minutes, in some embodiments about one minute. When the short has cleared, the short circuit protection can turn the panel back to an operational mode. If the short has not cleared, the short circuit protection can put the system into a safe mode (i.e. off), until the short has cleared. If the short has not cleared after between about 12 hours and about 72 hours, in some embodiments about 24 hours, a signal or message can be sent to a user. The control manager can also be used to turn the system to an operational mode. The control manager can compare the battery voltage to the solar panel. When the battery voltage is greater than the solar panel, the panel can turn on (i.e. operational mode). The control manager can also be equipped with a timer that turns the system, or components of the system, on and off as desired. In some embodiments, the operational period can be between about 8-12 hours. In other embodiments, when the battery voltage is less than the solar panel, the panel can turn off. The panel can be operational from dusk for a period of time. The period of time can be between about 8 hours and 12 hours, in some embodiments about 10 hours, in other embodiments longer than 12 hours depending upon power availability.

Components in the system can be monitored remotely. In some embodiments, the control manager panel can also monitor components in the system. A user can be notified, for example, when battery power is low, if the system is not working correctly (for example if there is an issue with a solar panel), if the life of a battery is low, or if the system is not optimally working (for example if the solar panel is not receiving optimal sunlight). Other components can also be monitored and recorded for the user, which can be remotely transmitted to the user. Thus, in some embodiments, the system can include a signal generator.

Advantageously, while power can be drawn to the system during the day with the solar panel, the system can be operational only after dusk. By operating during dark hours of the day, the system cannot and does not attract pollinating insects that are active during the light hours of the day. Rather, the operation of the insect attracting elements are configured to not attract pollinating insects. Instead, the system can be used at that time period to attract insects that are harmful to agriculture and humans. These insects can be selected from the group consisting of an insect from a subject/order selected from the group consisting of mitsubishi, orthopteran, homopterous, rhynogta, coleopteran, lepidoptera, hymenoptera, diptera, and combinations thereof. Specific insects include termites, crickets, slugs, locusts, leaf hoppers, bugs, moths, chafers, scarabs, worms, longicorns, weevils, mosquitos, maggots, cockroaches, house flies, wasps, buzzers, green leafhoppers, migratory locusts, slugs, green leafhoppers, tettigonlidaes, northern china crickets, house termites, a Huainan local termites, black wing local termites, green mirid bugs, banana lace bugs, ping stinkbugs, changes stinkbugs, strip bee green stinkbugs, velvety chafers, verdigris scarabs, apple gooding worms, mulberry longicorns, spotted cerabycids, black sani tortoises, white spotted flower chafers, codling moths, a. transitella—navel orangewood worms, corn ear worm moths, green scaly weevils, grape horn worms, cacaecia crateagans, copper geometrides, twill leaf miners, bore fruit moths, cut worms, pine caterpillars, navicular caterpillars, persimmon fruit worms, oriental moths, grape said encleiades, locusts, plow solid bees, plow stem buzzers, wasps, peach wasps, mosquitoes, yellow fever mosquitos, zika carrying mosquitoes, dengue carrying mosquitoes, lutzomyia corn seed maggots, orange euribiidaes, and combinations thereof.

The system can be mounted using any suitable device or tool. By way of example, the system can be mounted on a pole or on the side of a building. A framed hanger can be used to mount the system. Furthermore, multiple operational panels can be combined to form a system.

The present disclosure is directed to an insect control system. The insect control system includes a power source, a light source; and an electrical grid.

The light source can emit light in a wavelength between 250 nm and 650 nm. The light source can be fluorescent, luminescent light, or a LED, including an OLED, and combinations thereof. In some embodiments, multiple light sources can be used, which can emit the same or different wavelengths of light. Different wavelengths can be more or less attractive to insects. The light source can be emitted as at least one spot, dot, strip, panel, triangle, oval, rectangle or any other suitable and/or desired shape. The light source can also be a plurality of light sources or can emit at least two wavelengths of light. The light can be from a Lambertian emitter. The lights can emit light at wavelengths between about 250 nm and about 800 nm, in some embodiments about 300 to 650 nanometer, in some embodiments between 350 to 480 nanometers. In some embodiments, the light source can be an electroluminescent light that can be blue in color and in the range of 400 nm to 480 nm. In some embodiments, the light source can be a LED light, which can be green in color and about 525 nm. In some embodiments, the light source (electroluminescent or otherwise) can pulse. In embodiments where multiple light sources are used, each light source can pulse at the same frequency or at different frequencies. The frequency of the pulse can be between about 100 Hz and about 2000 Hz. In some embodiments, the frequency of the pulse can be between about 100 Hz and about 600 Hz, about 350 Hz to about 550 Hz, about 100 Hz to about 1000 Hz, or between about 100 Hz and about 1500 Hz. In some embodiments, the frequency can change from a first frequency to a second frequency, or to additional frequencies. The frequency can change by either scanning or by hopping. Scanning as used herewith means to change values in a consecutive or sequential order, either increasing or decreasing in value using a non-integer method for example the charging of a capacitor where there is a smooth transition from one frequency to another while hitting all the frequencies in between. For example, transitioning gradually from 350 Hz to 400 Hz while hitting all the frequencies in between. Hopping means to change from a first value to a second value in a digital move, where the first value and the second value are incrementally different and may or may not be consecutive. For example, a first value might be 350 Hz, and a second value might be 600 Hz, and a third value might be 400 Hz. Frequency hopping is more likely to be digital and programmed in nature and not relying on a physical process like charging a capacitor. In some embodiments, the light source can be chosen based on the time of day that the system will be used. By way of example, it can be beneficial to use an EL light during night time hours and a LED light during daytime hours. In some embodiments, the light source can also act as the sound generating device.

The electric grid can be made from an electrically conductive material. Suitable materials include stainless steel, silver, copper, gold, aluminum, titanium, similar materials, and combinations thereof. In some embodiments, the material can be 304 or 316 stainless steel. The electrical grid can be mesh cloth. The grid openings of the electrical grid can be any suitable size, including openings between about 0.1 and about 1.0 inches, in some embodiments about 0.25 inches to 0.5 inches. In some embodiments, the grid can be a number 2 grid (i.e. two grids per linear inch), a number 3 grid (i.e. three grids per linear inch), or a number 4 grid (i.e. four grids per linear inch). The size of the grids can be determined based on the size of the insects to be attracted by the system. In some embodiments, more than one grid can be used in the system. The grids can be the same size or different sizes. In some embodiments when more than one grid is used, the grids can be spaced such that the larger grid can be placed in front of the smaller grid (i.e. the larger grid is closer to the opening of the panel). The grids can be sized to allow light and scents to transmit through the grids. A spacer can be used to separate the materials. The spacer between the grids can be between about 0.1 inches and about 2 inches, in some embodiments about 0.25 inches and in some embodiments about 0.50 inches.

The system can further include an attraction sensory panel. The attraction sensory panel can include multiple sensory operations in a single device. The attraction sensory panel can include the light source. The attraction sensory panel can include a pheromone and/or scent. In some embodiments, the attraction sensory panel can further include at least one heater, for example a self-limiting heated strip, and at least one pheromone or scent. In an embodiment of the invention, at least one heater can be located adjacent to the light source. Pheromones or scents within the attraction sensory panel can be replaced as needed, for example on a semiannually or annual basis. The heated strip can be graphite based. Pheromones can be used to attract insects to the system for electrocution. The pheromones or scent can be selected to attract one or more specific insects. More than one pheromone can be used in the system to attract more than one insect. Suitable scents can include, but are not limited to, scents associated with food, including carbon dioxide, reproduction and egg laying, and combinations thereof. Scents that attract egg laying insects can include butyric acid and hexanoic acid. Scent associated with food may include materials found in animal sweat, including nonanal, lactic acid, butyric acid, hexanoic acid and other acids or esters with a molecular weight of less than 120, octanol, and low molecular weight carboxylic acids, and combinations thereof. For scents that mimic food concentrations between about 0.01% and about 30% can be used. Using concentrations from between 0.1% and about 20% to attract insects can be more beneficial. 0.001% and about 5%, with target ranges between 0.01% and about 2% to 0.01% being more beneficial. In some embodiments, a fan can be used to distribute the scent or pheromone. The attraction sensory panel can be polymeric material, for example an acrylic material. In some embodiments, the attraction sensory panel can include a fan and at least one switch for each scent or group of scents to turn additional scents on or off in the panel. Activation of the switch may be controlled by a processor, timer, light sensor or other methods know to those of skill in the art. In some embodiments, the attraction sensory panel can also include a separate power storage device or the battery for the system.

The pheromone and/or scent can be in a polymer matrix, silica gel or activated carbon or another porous carrier. The polymers used can include UV or heat cured polyurethanes, acrylics, and vinyl, inks and combinations thereof. The heater can heat the polymer matrix thereby enhancing the release of the pheromone and/or scent, which can be in the matrix. In some embodiments, multiple pheromones and/or scent can be used which can be activated in the attraction sensory panel at separate times to increase the release of a particular pheromone and/or scent, or simultaneously in the same or different quantities. In some embodiments, a computer program or programmable device can be used to activate or disable the heater. In some embodiments, the program or programmable device can control the heater and/or the pheromone release such that the scent from the pheromones or scents are released during predetermined times or for a predetermined duration. The predetermined time can be for any duration during a day, week, month, or year. The predetermined duration can be for between about 1 minute and about 24 hours. In some embodiments, the predetermined time can be for one hour, two hours, five hours, or ten hours. By way of example only, the attraction sensory panel can include pheromone A and scent B, each within a polymer matrix. The heater associated with pheromone A can be turned on to increase the release of pheromone A. The heater associated with scent B can remain off, thereby increasing the release of pheromone A compared to scent B. Alternatively, both heaters can be activated simultaneously and the temperature varied at each heater to produce a desired mixture of pheromone A and B. In some embodiments, a sonic device can be used to release the pheromones and/or scent by vibration. Suitable devices include, but are not limited to, a sonic with the integrated barium titanate dielectric array, piezoelectric speakers or coil driven speakers, or combinations thereof. The attraction sensory panel can be between about 4 inches and about 12 inches wide and about 6 inches to about 28 inches long, and, between about 0.1 and about 0.5 inches thick, in some embodiments the sensory panel is about 6 inches by about 18 inches about 0.25 inches thick. The attraction sensory panel can be a polymeric material. In some embodiments, the polymeric material can be acrylic composite. Other suitable materials can include polycarbonate or another stiff transparent plastic. In some embodiments, the polymer can by ultraviolet stabilized. These matrixes can be placed on EL lamps or other warming elements where the heat can help to volatilize and transmit these scents into the air.

The attraction sensory panel can be on a fixed panel in the device. In some embodiments, the attraction sensory panel can become the fixed panel once assembled into the operational panel. In some embodiments, the attraction sensory panel can be attached to a fixed panel in the operational panel. By way of example only, the light source and the attraction sensory panel can be on the back side of the system. In these embodiments, the light source and the attraction sensory panel can be oriented in any direction on the fixed panel. The electrical grid can be located in front of the fixed panel. The system can further include a frequency emitting device. The frequency emitting device can be used to produce sounds that can trap insects in the system by disrupting the vibrational communication between insects. The frequency can be between about 100 Hz and about 2000 Hz can be used but a narrow range of about 350 Hz to about 550 Hz can be more focused to get the desired results. Frequency hopping (as described above) can be done at different intervals for example 25 Hz steps for 5 to 600 seconds at each step or the steps can be proportional for example like musical notes from F4 (349.23 Hz) to C#5 (554.37 Hz). In some embodiments, the frequency can change by scanning. The amplitude can vary depending upon the foliage where the system is located. In some embodiments, the sound emitted can be calibrated to the insect to be terminated. The frequency emitting device can be the heated strip, the light source or another device in the system. In some embodiments, the components of the system can oscillate to create the emitting frequency. For example, the inverter of the system can generate a frequency.

The system, or components of the system, can be powered by a power source. The power source can be from at least one battery, solar energy, electricity, coal, water power, geothermal, natural gas, oil, or combinations thereof. In some embodiments, the power source can be used to charge at least one battery associated with the panel for subsequent use.

A solar panel can be used to charge at least one power source or battery for use by the system. The solar panel can have a wattage between about 1 W and about 100 W, in some embodiments about 20 W. The solar panel can produce between about 10 V and about 30 V, in some embodiments about 21 V. The solar panel can also produce between about 0.1 A and about 10 A, in some embodiments about 1 A. The dimensions of the solar panel can be between 6 inches and 36 inches, by between 10 inches and 24 inches, by between 13 inches and 20 inches. In some embodiments, the dimensions of the solar panel can be 20 inches by 13.37 inches by 1.375 inches thick. Suitable solar powered system includes, but are not limited to, systems produced by Infinium Solar, Sun Power, Kyocera, Ameresco Solar and combinations thereof. More than one solar panel can be used to achieve the required power to operate the system. Cables that attach the solar panel to the operation panel can be UV stabilized, and suitable for outdoor use. In some embodiments, the cables can be covered by a material to protect the cable from weather. By way of example only, the cables can be PVC coated copper wires. The wires can be between about 12 and about 24 AWG, in some embodiments about 16 AWG.

The system can include at least one power storage device, such as a battery. Multiple batteries can be joined in series or in parallel. Each battery can be rated for between about 3.7 and 24 V, in some embodiments about 12 V. When the batteries are powered in an inverter, they can create greater than about 2500 V. The inverter voltage may be increased by use of a boost inverter, a buck inverter or a voltage multiplier for example a capacitor and diode bridge. Each battery can be rated for between about 1 and 30 Amp-hours, in some embodiments about 9 Amp-hours. Each battery can operate at a temperature between about −40° C. and about 60° C. The battery can be weatherproof, or located in a weatherproof container. The weight of each battery can be between about 1 lb and about 5 lbs, in some embodiments about 2.8 lbs. The battery can be used to power components in the system, or components of the system, including a microprocessor which can control the light source, a boost inverter, and a voltage multiplier. A boost inverter can be used to convert direct current into alternating current. A boost inverter can build a magnetic field in an inductor, then turned off to stop current flow. A voltage pulse can be generated as the magnetic field collapses. A voltage multiplier can be used to power the electrical grid.

The attraction sensory panel, frequency emitting device, electronic components, power components, and electrical grid can be in an operation panel. In some embodiments, components, for example batteries, and the power supply, can be exterior to the operational panel. The operational panel can be a container, such as a box, that is open on one side. One side of the panel can be the fixed panel. The grids can be positioned over the attraction sensory panel and attach to the side panels of the operational panel. The operational panel can also include a protective panel on the open side of the operational panel over the grids. The protective panel can be sized according to the size of the operational panel. The protective panel can prevent animals, such as birds or humans from contacting the electrical grid. The length of the panel can be between about 6 inches and about 48 inches. The width of the panel can be between about 1 inch and about 12 inches, and the height of the panel can be between about 0.5 inches and about 48 inches. In some embodiments, the length of the panel can be about 18 inches, the width of the panel can be about 4 inches, and the height of a panel can be about 6 inches. Suitable materials for the operational panel can include any non-corrosive material, including but not limited to stainless steel, coated aluminum, titanium, aluminum alloys, and combinations thereof. In some embodiments, the material of the operational panel can be 304 stainless steel.

The system can further comprise a control manager. The control manager of the system can manage the charge control of power from the solar panel to the battery. The control manager can also include a short circuit protection. The short circuit protection can determine if there is a short in the panel, for example, a short caused by weather. If a short has been found, then the short circuit protection can determine if the short has cleared. For example, the short circuit protection can determine if the short has cleared after a time of between 30 seconds and about 5 minutes, in some embodiments about one minute. When the short has cleared, the short circuit protection can turn the panel back to an operational mode. If the short has not cleared, the short circuit protection can put the system into a safe mode (i.e. off), until the short has cleared. If the short has not cleared after between about 12 hours and about 72 hours, in some embodiments about 24 hours, a signal or message can be sent to a user. The control manager can also be used to turn the system to an operational mode. The control manager can compare the battery voltage to the solar panel. When the battery voltage is greater than the solar panel, the panel can turn on (i.e. operational mode). The control manager can also be equipped with a timer that turns the system, or components of the system, on and off as desired. In some embodiments, the operational period can be between about 8-12 hours. In other embodiments, when the battery voltage is less than the solar panel, the panel can turn off. The panel can be operational from dusk for a period of time. The period of time can be between about 8 hours and 12 hours, in some embodiments about 10 hours, in other embodiments longer than 12 hours depending upon power availability.

Components in the system can be monitored remotely. In some embodiments, the control manager panel can also monitor components in the system. A user can be notified, for example, when battery power is low, if the system is not working correctly (for example if there is an issue with a solar panel), if the life of a battery is low, or if the system is not optimally working (for example if the solar panel is not receiving optimal sunlight). Other components can also be monitored and recorded for the user, which can be remotely transmitted to the user. Thus, in some embodiments, the system can include a signal generator.

Advantageously, while power can be drawn to the system during the day with the solar panel, the system can be operational only after dusk. By operating during dark hours of the day, the system cannot and does not attract pollinating insects that are active during the light hours of the day. Rather, the operation of the insect attracting elements are configured to not attract pollinating insects. Instead, the system can be used at that time period to attract insects that are harmful to agriculture and humans. These insects can be selected from the group consisting of an insect from a subject/order selected from the group consisting of mitsubishi, orthopteran, homopterous, rhynogta, coleopteran, lepidoptera, hymenoptera, diptera, and combinations thereof. Specific insects include termites, crickets, slugs, locusts, leaf hoppers, bugs, moths, chafers, scarabs, worms, longicorns, weevils, mosquitos, maggots, cockroaches, house flies, wasps, buzzers, green leafhoppers, migratory locusts, slugs, green leafhoppers, tettigonlidaes, northern china crickets, house termites, a Huainan local termites, black wing local termites, green mirid bugs, banana lace bugs, ping stinkbugs, changes stinkbugs, strip bee green stinkbugs, velvety chafers, verdigris scarabs, apple gooding worms, mulberry longicorns, spotted cerabycids, black sani tortoises, white spotted flower chafers, codling moths, a. transitella—navel orangewood worms, corn ear worm moths, green scaly weevils, grape horn worms, cacaecia crateagans, copper geometrides, twill leaf miners, bore fruit moths, cut worms, pine caterpillars, navicular caterpillars, persimmon fruit worms, oriental moths, grape said encleiades, locusts, plow solid bees, plow stem buzzers, wasps, peach wasps, mosquitoes, yellow fever mosquitos, zika carrying mosquitoes, dengue carrying mosquitoes, lutzomyia corn seed maggots, orange euribiidaes, and combinations thereof.

The insect control system can be used over an area of coverage that can be up to about 20 acres, in some embodiments between about 10 and 15 acres. The present invention can reduce operating expenses for insect control by more than about 40%, and attract as much as about 90% of harmful insects from the area of coverage.

The system can be affixed to a side of a building, or other structure, such as a pole. It can be placed in an elevated position so that it is out of reach of humans or animals. The panel can be quickly installed by attaching the panel to framed hangers.

The present disclosure is directed to an insect electrocution system. The system includes a solar panel, at least one power storage device, at least one electrocution grid and insect trap, and an operational panel. The power storage device stores energy from the solar panel. The operational panel includes at least two of the following insect attracting elements: a first electroluminescent light source that is a Lambertian emitter, a second electroluminescent light source that operates at a different wavelength than the first electroluminescent light source, at least one of the first and second electroluminescent light source pulses, at least one sound source, and at least one scent source. The power storage device provides power for the at least two attracting systems, and the at least one electrocution grid.

The operational panel can further include a sensor. The sensor can control the activation or deactivation of at least the insect attracting elements. By way of example, the sensor can sense time or ambient light.

The operational panel can include a first light source that supplies at least one light at a wavelength of between about 300 nm and about 600 nm. The light source can be an electroluminescent light source or a point light source, or combinations thereof. The system can further include a light source. The light source can emit light in a wavelength between 250 nm and 650 nm. The light source can be fluorescent, luminescent light, or a LED, including an OLED, and combinations thereof. In some embodiments, multiple light sources can be used, which can emit the same or different wavelengths of light. Different wavelengths can be more or less attractive to insects. The light source can be emitted as at least one spot, dot, strip, panel, triangle, oval, rectangle or any other suitable and/or desired shape. The light source can also be a plurality of light sources or can emit at least two wavelengths of light. The light can be from a Lambertian emitter. The lights can emit light at wavelengths between about 250 nm and about 800 nm, in some embodiments about 300 to 650 nanometer, in some embodiments between 350 to 480 nanometers. In some embodiments, the light source can be an electroluminescent light that can be blue in color and in the range of 400 nm to 480 nm. In some embodiments, the light source can be a LED light, which can be green in color and about 525 nm. In some embodiments, the light source (electroluminescent or otherwise) can pulse. In embodiments where multiple light sources are used, each light source can pulse at the same frequency or at different frequencies. The frequency of the pulse can be between about 100 Hz and about 2000 Hz. In some embodiments, the frequency of the pulse can be between about 100 Hz and about 600 Hz, about 350 Hz to about 550 Hz, about 100 Hz to about 1000 Hz, or between about 100 Hz and about 1500 Hz. In some embodiments, the frequency can change from a first frequency to a second frequency, or to additional frequencies. The frequency can change by either scanning or by hopping. Scanning as used herewith means to change values in a consecutive or sequential order, either increasing or decreasing in value using a non-integer method for example the charging of a capacitor where there is a smooth transition from one frequency to another while hitting all the frequencies in between. For example, transitioning gradually from 350 Hz to 400 Hz while hitting all the frequencies in between. Hopping means to change from a first value to a second value in a digital move, where the first value and the second value are incrementally different and may or may not be consecutive. For example, a first value might be 350 Hz, and a second value might be 600 Hz, and a third value might be 400 Hz. Frequency hopping is more likely to be digital and programmed in nature and not relying on a physical process like charging a capacitor. In some embodiments, the light source can be chosen based on the time of day that the system will be used. By way of example, it can be beneficial to use an EL light during night time hours and a LED light during daytime hours. In some embodiments, the light source can also act as the sound generating device.

The electric grid can be made from an electrically conductive material. Suitable materials include stainless steel, silver, copper, gold, aluminum, titanium, similar materials, and combinations thereof. In some embodiments, the material can be 304 or 316 stainless steel. The electrical grid can be mesh cloth. The grid openings of the electrical grid can be any suitable size, including openings between about 0.1 and about 1.0 inches, in some embodiments about 0.25 inches to 0.5 inches. In some embodiments, the grid can be a number 2 grid (i.e. two grids per linear inch), a number 3 grid (i.e. three grids per linear inch), or a number 4 grid (i.e. four grids per linear inch). The size of the grids can be determined based on the size of the insects to be attracted by the system. In some embodiments, more than one grid can be used in the system. The grids can be the same size or different sizes. In some embodiments when more than one grid is used, the grids can be spaced such that the larger grid can be placed in front of the smaller grid (i.e. the larger grid is closer to the opening of the panel). The grids can be sized to allow light and scents to transmit through the grids. A spacer can be used to separate the materials. The spacer between the grids can be between about 0.1 inches and about 2 inches, in some embodiments about 0.25 inches and in some embodiments about 0.50 inches.

The system can further include an attraction sensory panel. The attraction sensory panel can include multiple sensory operations in a single device. The attraction sensory panel can include the light source. The attraction sensory panel can include a pheromone and/or scent. In some embodiments, the attraction sensory panel can further include at least one heater, for example a self-limiting heated strip, and at least one pheromone or scent. In an embodiment of the invention, at least one heater can be located adjacent to the light source. Pheromones or scents within the attraction sensory panel can be replaced as needed, for example on a semiannually or annual basis. The heated strip can be graphite based. Pheromones can be used to attract insects to the system for electrocution. The pheromones or scent can be selected to attract one or more specific insects. More than one pheromone can be used in the system to attract more than one insect. Suitable scents can include, but are not limited to, scents associated with food, including carbon dioxide, reproduction and egg laying, and combinations thereof. Scents that attract egg laying insects can include butyric acid and hexanoic acid. Scent associated with food may include materials found in animal sweat, including nonanal, lactic acid, butyric acid, hexanoic acid and other acids or esters with a molecular weight of less than 120, octanol, and low molecular weight carboxylic acids, and combinations thereof. For scents that mimic food concentrations between about 0.01% and about 30% can be used. Using concentrations from between 0.1% and about 20% to attract insects can be more beneficial. 0.001% and about 5%, with target ranges between 0.01% and about 2% to 0.01% being more beneficial. In some embodiments, a fan can be used to distribute the scent or pheromone. The attraction sensory panel can be polymeric material, for example an acrylic material. In some embodiments, the attraction sensory panel can include a fan and at least one switch for each scent or group of scents to turn additional scents on or off in the panel. Activation of the switch may be controlled by a processor, timer, light sensor or other methods know to those of skill in the art. In some embodiments, the attraction sensory panel can also include a separate power storage device or the battery for the system.

The pheromone and/or scent can be in a polymer matrix, silica gel or activated carbon or another porous carrier. The polymers used can include UV or heat cured polyurethanes, acrylics, and vinyl, inks and combinations thereof. The heater can heat the polymer matrix thereby enhancing the release of the pheromone and/or scent, which can be in the matrix. In some embodiments, multiple pheromones and/or scent can be used which can be activated in the attraction sensory panel at separate times to increase the release of a particular pheromone and/or scent, or simultaneously in the same or different quantities. In some embodiments, a computer program or programmable device can be used to activate or disable the heater. In some embodiments, the program or programmable device can control the heater and/or the pheromone release such that the scent from the pheromones or scents are released during predetermined times or for a predetermined duration. The predetermined time can be for any duration during a day, week, month, or year. The predetermined duration can be for between about 1 minute and about 24 hours. In some embodiments, the predetermined time can be for one hour, two hours, five hours, or ten hours. By way of example only, the attraction sensory panel can include pheromone A and scent B, each within a polymer matrix. The heater associated with pheromone A can be turned on to increase the release of pheromone A. The heater associated with scent B can remain off, thereby increasing the release of pheromone A compared to scent B. Alternatively, both heaters can be activated simultaneously and the temperature varied at each heater to produce a desired mixture of pheromone A and B. In some embodiments, a sonic device can be used to release the pheromones and/or scent by vibration. Suitable devices include, but are not limited to, a sonic with the integrated barium titanate dielectric array, piezoelectric speakers or coil driven speakers, or combinations thereof. The attraction sensory panel can be between about 4 inches and about 12 inches wide and about 6 inches to about 28 inches long, and, between about 0.1 and about 0.5 inches thick, in some embodiments the sensory panel is about 6 inches by about 18 inches about 0.25 inches thick. The attraction sensory panel can be a polymeric material. In some embodiments, the polymeric material can be acrylic composite. Other suitable materials can include polycarbonate or another stiff transparent plastic. In some embodiments, the polymer can by ultraviolet stabilized. These matrixes can be placed on EL lamps or other warming elements where the heat can help to volatilize and transmit these scents into the air.

The attraction sensory panel can be on a fixed panel in the device. In some embodiments, the attraction sensory panel can become the fixed panel once assembled into the operational panel. In some embodiments, the attraction sensory panel can be attached to a fixed panel in the operational panel. By way of example only, the light source and the attraction sensory panel can be on the back side of the system. In these embodiments, the light source and the attraction sensory panel can be oriented in any direction on the fixed panel. The electrical grid can be located in front of the fixed panel. The system can further include a frequency emitting device. The frequency emitting device can be used to produce sounds that can trap insects in the system by disrupting the vibrational communication between insects. The frequency can be between about 100 Hz and about 2000 Hz can be used but a narrow range of about 350 Hz to about 550 Hz can be more focused to get the desired results. Frequency hopping (as described above) can be done at different intervals for example 25 Hz steps for 5 to 600 seconds at each step or the steps can be proportional for example like musical notes from F4 (349.23 Hz) to C#5 (554.37 Hz). In some embodiments, the frequency can change by scanning. The amplitude can vary depending upon the foliage where the system is located. In some embodiments, the sound emitted can be calibrated to the insect to be terminated. The frequency emitting device can be the heated strip, the light source or another device in the system. In some embodiments, the components of the system can oscillate to create the emitting frequency. For example, the inverter of the system can generate a frequency.

The system, or components of the system, can be powered by an energy source. The energy source can be from at least one battery, solar energy, electricity, coal, water power, geothermal, natural gas, oil, or combinations thereof. In some embodiments, the energy source can be used to charge at least one battery associated with the panel for subsequent use.

A solar panel can be used to charge at least one battery for use by the system. The solar panel can have a wattage between about 1 W and about 100 W, in some embodiments about 20 W. The solar panel can produce between about 10 V and about 30 V, in some embodiments about 21 V. The solar panel can also produce between about 0.1 A and about 10 A, in some embodiments about 1 A. The dimensions of the solar panel can be between 6 inches and 36 inches, by between 10 inches and 24 inches, by between 13 inches and 20 inches. In some embodiments, the dimensions of the solar panel can be 20 inches by 13.37 inches by 1.375 inches thick. Suitable solar powered system includes, but are not limited to, systems produced by Infinium Solar, Sun Power, Kyocera, Ameresco Solar and combinations thereof. More than one solar panel can be used to achieve the required power to operate the system. Cables that attach the solar panel to the operation panel can be UV stabilized, and suitable for outdoor use. In some embodiments, the cables can be covered by a material to protect the cable from weather. By way of example only, the cables can be PVC coated copper wires. The wires can be between about 12 and about 24 AWG, in some embodiments about 16 AWG.

The system includes at least one power storage device, such as a battery. Multiple batteries can be joined in series or in parallel. Each battery can be rated for between about 3.7 and 24 V, in some embodiments about 12 V. When the batteries are powered in an inverter, they can create greater than about 2500 V. The inverter voltage may be increased by use of a boost inverter, a buck inverter or a voltage multiplier for example a capacitor and diode bridge. Each battery can be rated for between about 1 and 30 Amp-hours, in some embodiments about 9 Amp-hours. Each battery can operate at a temperature between about −40° C. and about 60° C. The battery can be weatherproof, or located in a weatherproof container. The weight of each battery can be between about 1 lb and about 5 lbs, in some embodiments about 2.8 lbs. The battery can be used to power components in the system, or components of the system, including a microprocessor which can control the light source, a boost inverter, and a voltage multiplier. A boost inverter can be used to convert direct current into alternating current. A boost inverter can build a magnetic field in an inductor, then turned off to stop current flow. A voltage pulse can be generated as the magnetic field collapses. A voltage multiplier can be used to power the electrical grid.

The attraction sensory panel, frequency emitting device, electronic components, power components, and electrical grid can be in an operation panel. In some embodiments, components, for example batteries, and the power supply, can be exterior to the operational panel. The operational panel can be a container, such as a box, that is open on one side. One side of the panel can be the fixed panel. The grids can be positioned over the attraction sensory panel and attach to the side panels of the operational panel. The operational panel can also include a protective panel on the open side of the operational panel over the grids. The protective panel can be sized according to the size of the operational panel. The protective panel can prevent animals, such as birds or humans from contacting the electrical grid. The length of the panel can be between about 6 inches and about 48 inches. The width of the panel can be between about 1 inch and about 12 inches, and the height of the panel can be between about 0.5 inches and about 48 inches. In some embodiments, the length of the panel can be about 18 inches, the width of the panel can be about 4 inches, and the height of a panel can be about 6 inches. Suitable materials for the operational panel can include any non-corrosive material, including but not limited to stainless steel, coated aluminum, titanium, aluminum alloys, and combinations thereof. In some embodiments, the material of the operational panel can be 304 stainless steel.

The system can further comprise a control manager. The control manager of the system can manage the charge control of power from the solar panel to the battery. The control manager can also include a short circuit protection. The short circuit protection can determine if there is a short in the panel, for example, a short caused by weather. If a short has been found, then the short circuit protection can determine if the short has cleared. For example, the short circuit protection can determine if the short has cleared after a time of between 30 seconds and about 5 minutes, in some embodiments about one minute. When the short has cleared, the short circuit protection can turn the panel back to an operational mode. If the short has not cleared, the short circuit protection can put the system into a safe mode (i.e. off), until the short has cleared. If the short has not cleared after between about 12 hours and about 72 hours, in some embodiments about 24 hours, a signal or message can be sent to a user. The control manager can also be used to turn the system to an operational mode. The control manager can compare the battery voltage to the solar panel. When the battery voltage is greater than the solar panel, the panel can turn on (i.e. operational mode). The control manager can also be equipped with a timer that turns the system, or components of the system, on and off as desired. In some embodiments, the operational period can be between about 8-12 hours. In other embodiments, when the battery voltage is less than the solar panel, the panel can turn off. The panel can be operational from dusk for a period of time. The period of time can be between about 8 hours and 12 hours, in some embodiments about 10 hours, in other embodiments longer than 12 hours depending upon power availability.

Components in the system can be monitored remotely. In some embodiments, the control manager panel can also monitor components in the system. A user can be notified, for example, when battery power is low, if the system is not working correctly (for example if there is an issue with a solar panel), if the life of a battery is low, or if the system is not optimally working (for example if the solar panel is not receiving optimal sunlight). Other components can also be monitored and recorded for the user, which can be remotely transmitted to the user. Thus, in some embodiments, the system can include a signal generator.

Advantageously, while power can be drawn to the system during the day with the solar panel, the system can be operational only after dusk. By operating during dark hours of the day, the system cannot and does not attract pollinating insects that are active during the light hours of the day. Rather, the operation of the insect attracting elements are configured to not attract pollinating insects. Instead, the system can be used at that time period to attract insects that are harmful to agriculture and humans. These insects can be selected from the group consisting of an insect from a subject/order selected from the group consisting of mitsubishi, orthopteran, homopterous, rhynogta, coleopteran, lepidoptera, hymenoptera, diptera, and combinations thereof. Specific insects include termites, crickets, slugs, locusts, leaf hoppers, bugs, moths, chafers, scarabs, worms, longicorns, weevils, mosquitos, maggots, cockroaches, house flies, wasps, buzzers, green leafhoppers, migratory locusts, slugs, green leafhoppers, tettigonlidaes, northern china crickets, house termites, a Huainan local termites, black wing local termites, green mirid bugs, banana lace bugs, ping stinkbugs, changes stinkbugs, strip bee green stinkbugs, velvety chafers, verdigris scarabs, apple gooding worms, mulberry longicorns, spotted cerabycids, black sani tortoises, white spotted flower chafers, codling moths, a. transitella—navel orangewood worms, corn ear worm moths, green scaly weevils, grape horn worms, cacaecia crateagans, copper geometrides, twill leaf miners, bore fruit moths, cut worms, pine caterpillars, navicular caterpillars, persimmon fruit worms, oriental moths, grape said encleiades, locusts, plow solid bees, plow stem buzzers, wasps, peach wasps, mosquitoes, yellow fever mosquitos, zika carrying mosquitoes, dengue carrying mosquitoes, lutzomyia corn seed maggots, orange euribiidaes, and combinations thereof.

The system can be mounted using any suitable device or tool. By way of example, the system can be mounted on a pole or on the side of a building. A framed hanger can be used to mount the system. Furthermore, multiple operational panels can be combined to form a system.

The present invention is directed to a method to execute non-pollinating insects. The method includes providing a system to a field. The system includes at least one light emitting source, and an electrocution grid within an operation panel. The emitting light attracts the non-pollinating insect to the system. The electrocution grid electrocutes the non-pollinating insect after the non-pollinating insect is attracted to the system.

The operational panel can further include a sensor. The sensor can control the activation or deactivation of at least the insect attracting elements. By way of example, the sensor can sense time or ambient light.

The operational panel can include a light source that supplies at least one light at a wavelength of between about 300 nm and about 600 nm. The light source or light emitting source can emit light in a wavelength between 250 nm and 650 nm. The light source or light emitting source can be fluorescent, luminescent light, or a LED, including an OLED, and combinations thereof. In some embodiments, multiple light sources or light emitting sources can be used, which can emit the same or different wavelengths of light. Different wavelengths can be more or less attractive to insects. The light source or light emitting source can be emitted as at least one spot, dot, strip, panel, triangle, oval, rectangle or any other suitable and/or desired shape. The light source or light emitting source can also be a plurality of light sources or can emit at least two wavelengths of light. The light can be from a Lambertian emitter. The lights can emit light at wavelengths between about 250 nm and about 800 nm, in some embodiments about 300 to 650 nanometer, in some embodiments between 350 to 480 nanometers. In some embodiments, the light source or light emitting source can be an electroluminescent light that can be blue in color and in the range of 400 nm to 480 nm. In some embodiments, the light source or light emitting source can be a LED light, which can be green in color and about 525 nm. In some embodiments, the light source (electroluminescent or otherwise) can pulse. In embodiments where multiple light sources are used, each light source can pulse at the same frequency or at different frequencies. The frequency of the pulse can be between about 100 Hz and about 2000 Hz. In some embodiments, the frequency of the pulse can be between about 100 Hz and about 600 Hz, about 350 Hz to about 550 Hz, about 100 Hz to about 1000 Hz, or between about 100 Hz and about 1500 Hz. In some embodiments, the frequency can change from a first frequency to a second frequency, or to additional frequencies. The frequency can change by either scanning or by hopping. Scanning as used herewith means to change values in a consecutive or sequential order, either increasing or decreasing in value using a non-integer method for example the charging of a capacitor where there is a smooth transition from one frequency to another while hitting all the frequencies in between. For example, transitioning gradually from 350 Hz to 400 Hz while hitting all the frequencies in between. Hopping means to change from a first value to a second value in a digital move, where the first value and the second value are incrementally different and may or may not be consecutive. For example, a first value might be 350 Hz, and a second value might be 600 Hz, and a third value might be 400 Hz. Frequency hopping is more likely to be digital and programmed in nature and not relying on a physical process like charging a capacitor. In some embodiments, the light source can be chosen based on the time of day that the system will be used. By way of example, it can be beneficial to use an EL light during night time hours and a LED light during daytime hours. In some embodiments, the light source can also act as the sound generating device.

The electric grid can be made from an electrically conductive material. Suitable materials include stainless steel, silver, copper, gold, aluminum, titanium, similar materials, and combinations thereof. In some embodiments, the material can be 304 or 316 stainless steel. The electrical grid can be mesh cloth. The grid openings of the electrical grid can be any suitable size, including openings between about 0.1 and about 1.0 inches, in some embodiments about 0.25 inches to 0.5 inches. In some embodiments, the grid can be a number 2 grid (i.e. two grids per linear inch), a number 3 grid (i.e. three grids per linear inch), or a number 4 grid (i.e. four grids per linear inch). The size of the grids can be determined based on the size of the insects to be attracted by the system. In some embodiments, more than one grid can be used in the system. The grids can be the same size or different sizes. In some embodiments when more than one grid is used, the grids can be spaced such that the larger grid can be placed in front of the smaller grid (i.e. the larger grid is closer to the opening of the panel). The grids can be sized to allow light and scents to transmit through the grids. A spacer can be used to separate the materials. The spacer between the grids can be between about 0.1 inches and about 2 inches, in some embodiments about 0.25 inches and in some embodiments about 0.50 inches.

The system can further include an attraction sensory panel. The attraction sensory panel can include multiple sensory operations in a single device. The attraction sensory panel can include the light source. The attraction sensory panel can include a pheromone and/or scent. In some embodiments, the attraction sensory panel can further include at least one heater, for example a self-limiting heated strip, and at least one pheromone or scent. In an embodiment of the invention, at least one heater can be located adjacent to the light source. Pheromones or scents within the attraction sensory panel can be replaced as needed, for example on a semiannually or annual basis. The heated strip can be graphite based. Pheromones can be used to attract insects to the system for electrocution. The pheromones or scent can be selected to attract one or more specific insects. More than one pheromone can be used in the system to attract more than one insect. Suitable scents can include, but are not limited to, scents associated with food, including carbon dioxide, reproduction and egg laying, and combinations thereof. Scents that attract egg laying insects can include butyric acid and hexanoic acid. Scent associated with food may include materials found in animal sweat, including nonanal, lactic acid, butyric acid, hexanoic acid and other acids or esters with a molecular weight of less than 120, octanol, and low molecular weight carboxylic acids, and combinations thereof. For scents that mimic food concentrations between about 0.01% and about 30% can be used. Using concentrations from between 0.1% and about 20% to attract insects can be more beneficial. 0.001% and about 5%, with target ranges between 0.01% and about 2% to 0.01% being more beneficial. In some embodiments, a fan can be used to distribute the scent or pheromone. The attraction sensory panel can be polymeric material, for example an acrylic material. In some embodiments, the attraction sensory panel can include a fan and at least one switch for each scent or group of scents to turn additional scents on or off in the panel. Activation of the switch may be controlled by a processor, timer, light sensor or other methods know to those of skill in the art. In some embodiments, the attraction sensory panel can also include a separate power storage device or the battery for the system.

The pheromone and/or scent can be in a polymer matrix, silica gel or activated carbon or another porous carrier. The polymers used can include UV or heat cured polyurethanes, acrylics, and vinyl, inks and combinations thereof. The heater can heat the polymer matrix thereby enhancing the release of the pheromone and/or scent, which can be in the matrix. In some embodiments, multiple pheromones and/or scent can be used which can be activated in the attraction sensory panel at separate times to increase the release of a particular pheromone and/or scent, or simultaneously in the same or different quantities. In some embodiments, a computer program or programmable device can be used to activate or disable the heater. In some embodiments, the program or programmable device can control the heater and/or the pheromone release such that the scent from the pheromones or scents are released during predetermined times or for a predetermined duration. The predetermined time can be for any duration during a day, week, month, or year. The predetermined duration can be for between about 1 minute and about 24 hours. In some embodiments, the predetermined time can be for one hour, two hours, five hours, or ten hours. By way of example only, the attraction sensory panel can include pheromone A and scent B, each within a polymer matrix. The heater associated with pheromone A can be turned on to increase the release of pheromone A. The heater associated with scent B can remain off, thereby increasing the release of pheromone A compared to scent B. Alternatively, both heaters can be activated simultaneously and the temperature varied at each heater to produce a desired mixture of pheromone A and B. In some embodiments, a sonic device can be used to release the pheromones and/or scent by vibration. Suitable devices include, but are not limited to, a sonic with the integrated barium titanate dielectric array, piezoelectric speakers or coil driven speakers, or combinations thereof. The attraction sensory panel can be between about 4 inches and about 12 inches wide and about 6 inches to about 28 inches long, and, between about 0.1 and about 0.5 inches thick, in some embodiments the sensory panel is about 6 inches by about 18 inches about 0.25 inches thick. The attraction sensory panel can be a polymeric material. In some embodiments, the polymeric material can be acrylic composite. Other suitable materials can include polycarbonate or another stiff transparent plastic. In some embodiments, the polymer can by ultraviolet stabilized. These matrixes can be placed on EL lamps or other warming elements where the heat can help to volatilize and transmit these scents into the air.

The attraction sensory panel can be on a fixed panel in the device. In some embodiments, the attraction sensory panel can become the fixed panel once assembled into the operational panel. In some embodiments, the attraction sensory panel can be attached to a fixed panel in the operational panel. By way of example only, the light source and the attraction sensory panel can be on the back side of the system. In these embodiments, the light source and the attraction sensory panel can be oriented in any direction on the fixed panel. The electrical grid can be located in front of the fixed panel. The system can further include a frequency emitting device. The frequency emitting device can be used to produce sounds that can trap insects in the system by disrupting the vibrational communication between insects. The frequency can be between about 100 Hz and about 2000 Hz can be used but a narrow range of about 350 Hz to about 550 Hz can be more focused to get the desired results. Frequency hopping (as described above) can be done at different intervals for example 25 Hz steps for 5 to 600 seconds at each step or the steps can be proportional for example like musical notes from F4 (349.23 Hz) to C#5 (554.37 Hz). In some embodiments, the frequency can change by scanning. The amplitude can vary depending upon the foliage where the system is located. In some embodiments, the sound emitted can be calibrated to the insect to be terminated. The frequency emitting device can be the heated strip, the light source or another device in the system. In some embodiments, the components of the system can oscillate to create the emitting frequency. For example, the inverter of the system can generate a frequency.

The system, or components of the system, can be powered by an energy source. The energy source can be from at least one battery, solar energy, electricity, coal, water power, geothermal, natural gas, oil, or combinations thereof. In some embodiments, the energy source can be used to charge at least one battery associated with the panel for subsequent use.

A solar panel can be used to charge at least one battery for use by the system. The solar panel can have a wattage between about 1 W and about 100 W, in some embodiments about 20 W. The solar panel can produce between about 10 V and about 30 V, in some embodiments about 21 V. The solar panel can also produce between about 0.1 A and about 10 A, in some embodiments about 1 A. The dimensions of the solar panel can be between 6 inches and 36 inches, by between 10 inches and 24 inches, by between 13 inches and 20 inches. In some embodiments, the dimensions of the solar panel can be 20 inches by 13.37 inches by 1.375 inches thick. Suitable solar powered system includes, but are not limited to, systems produced by Infinium Solar, Sun Power, Kyocera, Ameresco Solar and combinations thereof, combinations thereof. More than one solar panel can be used to achieve the required power to operate the system. Cables that attach the solar panel to the operation panel can be UV stabilized, and suitable for outdoor use. In some embodiments, the cables can be covered by a material to protect the cable from weather. By way of example only, the cables can be PVC coated copper wires. The wires can be between about 12 and about 24 AWG, in some embodiments about 16 AWG.

The system can include at least one power storage device, such as a battery. Multiple batteries can be joined in series or in parallel. Each battery can be rated for between about 3.7 and 24 V, in some embodiments about 12 V. When the batteries are powered in an inverter, they can create greater than about 2500 V. The inverter voltage may be increased by use of a boost inverter, a buck inverter or a voltage multiplier for example a capacitor and diode bridge. Each battery can be rated for between about 1 and 30 Amp-hours, in some embodiments about 9 Amp-hours. Each battery can operate at a temperature between about −40° C. and about 60° C. The battery can be weatherproof, or located in a weatherproof container. The weight of each battery can be between about 1 lb and about 5 lbs, in some embodiments about 2.8 lbs. The battery can be used to power components in the system, or components of the system, including a microprocessor which can control the light source, a boost inverter, and a voltage multiplier. A boost inverter can be used to convert direct current into alternating current. A boost inverter can build a magnetic field in an inductor, then turned off to stop current flow. A voltage pulse can be generated as the magnetic field collapses. A voltage multiplier can be used to power the electrical grid.

The attraction sensory panel, frequency emitting device, electronic components, power components, and electrical grid can be in an operation panel. In some embodiments, components, for example batteries, and the power supply, can be exterior to the operational panel. The operational panel can be a container, such as a box, that is open on one side. One side of the panel can be the fixed panel. The grids can be positioned over the attraction sensory panel and attach to the side panels of the operational panel. The operational panel can also include a protective panel on the open side of the operational panel over the grids. The protective panel can be sized according to the size of the operational panel. The protective panel can prevent animals, such as birds or humans from contacting the electrical grid. The length of the panel can be between about 6 inches and about 48 inches. The width of the panel can be between about 1 inch and about 12 inches, and the height of the panel can be between about 0.5 inches and about 48 inches. In some embodiments, the length of the panel can be about 18 inches, the width of the panel can be about 4 inches, and the height of a panel can be about 6 inches. Suitable materials for the operational panel can include any non-corrosive material, including but not limited to stainless steel, coated aluminum, titanium, aluminum alloys, and combinations thereof. In some embodiments, the material of the operational panel can be 304 stainless steel.

The system can further comprise a control manager. The control manager of the system can manage the charge control of power from the solar panel to the battery. The control manager can also include a short circuit protection. The short circuit protection can determine if there is a short in the panel, for example, a short caused by weather. If a short has been found, then the short circuit protection can determine if the short has cleared. For example, the short circuit protection can determine if the short has cleared after a time of between 30 seconds and about 5 minutes, in some embodiments about one minute. When the short has cleared, the short circuit protection can turn the panel back to an operational mode. If the short has not cleared, the short circuit protection can put the system into a safe mode (i.e. off), until the short has cleared. If the short has not cleared after between about 12 hours and about 72 hours, in some embodiments about 24 hours, a signal or message can be sent to a user. The control manager can also be used to turn the system to an operational mode. The control manager can compare the battery voltage to the solar panel. When the battery voltage is greater than the solar panel, the panel can turn on (i.e. operational mode). The control manager can also be equipped with a timer that turns the system, or components of the system, on and off as desired. In some embodiments, the operational period can be between about 8-12 hours. In other embodiments, when the battery voltage is less than the solar panel, the panel can turn off. The panel can be operational from dusk for a period of time. The period of time can be between about 8 hours and 12 hours, in some embodiments about 10 hours, in other embodiments longer than 12 hours depending upon power availability.

Components in the system can be monitored remotely. In some embodiments, the control manager panel can also monitor components in the system. A user can be notified, for example, when battery power is low, if the system is not working correctly (for example if there is an issue with a solar panel), if the life of a battery is low, or if the system is not optimally working (for example if the solar panel is not receiving optimal sunlight). Other components can also be monitored and recorded for the user, which can be remotely transmitted to the user. Thus, in some embodiments, the system can include a signal generator.

Advantageously, while power can be drawn to the system during the day with the solar panel, the system can be operational only after dusk. By operating during dark hours of the day, the system cannot and does not attract pollinating insects that are active during the light hours of the day. Rather, the operation of the insect attracting elements are configured to not attract pollinating insects. Instead, the system can be used at that time period to attract insects that are harmful to agriculture and humans. These insects can be selected from the group consisting of an insect from a subject/order selected from the group consisting of mitsubishi, orthopteran, homopterous, rhynogta, coleopteran, lepidoptera, hymenoptera, diptera, and combinations thereof. Specific insects include termites, crickets, slugs, locusts, leaf hoppers, bugs, moths, chafers, scarabs, worms, longicorns, weevils, mosquitos, maggots, cockroaches, house flies, wasps, buzzers, green leafhoppers, migratory locusts, slugs, green leafhoppers, tettigonlidaes, northern china crickets, house termites, a Huainan local termites, black wing local termites, green mirid bugs, banana lace bugs, ping stinkbugs, changes stinkbugs, strip bee green stinkbugs, velvety chafers, verdigris scarabs, apple gooding worms, mulberry longicorns, spotted cerabycids, black sani tortoises, white spotted flower chafers, codling moths, a. transitella—navel orangewood worms, corn ear worm moths, green scaly weevils, grape horn worms, cacaecia crateagans, copper geometrides, twill leaf miners, bore fruit moths, cut worms, pine caterpillars, navicular caterpillars, persimmon fruit worms, oriental moths, grape said encleiades, locusts, plow solid bees, plow stem buzzers, wasps, peach wasps, mosquitoes, yellow fever mosquitos, zika carrying mosquitoes, dengue carrying mosquitoes, lutzomyia corn seed maggots, orange euribiidaes, and combinations thereof.

The system can be mounted using any suitable device or tool. By way of example, the system can be mounted on a pole or on the side of a building. A framed hanger can be used to mount the system. Furthermore, multiple operational panels can be combined to form a system.

The present disclosure is directed to a method to control insects over an area. The method includes providing a system comprising a power source, a light source, and an electrical grid. The system attracts insects and the electrical grid terminates the insect.

The light source can emit light in a wavelength between 250 nm and 650 nm. The light source can be fluorescent, luminescent light, or a LED, including an OLED, and combinations thereof. In some embodiments, multiple light sources can be used, which can emit the same or different wavelengths of light. Different wavelengths can be more or less attractive to insects. The light source can be emitted as at least one spot, dot, strip, panel, triangle, oval, rectangle or any other suitable and/or desired shape. The light source can also be a plurality of light sources or can emit at least two wavelengths of light. The light can be from a Lambertian emitter. The lights can emit light at wavelengths between about 250 nm and about 800 nm, in some embodiments about 300 to 650 nanometer, in some embodiments between 350 to 480 nanometers. In some embodiments, the light source can be an electroluminescent light that can be blue in color and in the range of 400 nm to 480 nm. In some embodiments, the light source can be a LED light, which can be green in color and about 525 nm. In some embodiments, the light source (electroluminescent or otherwise) can pulse. In embodiments where multiple light sources are used, each light source can pulse at the same frequency or at different frequencies. The frequency of the pulse can be between about 100 Hz and about 2000 Hz. In some embodiments, the frequency of the pulse can be between about 100 Hz and about 600 Hz, about 350 Hz to about 550 Hz, about 100 Hz to about 1000 Hz, or between about 100 Hz and about 1500 Hz. In some embodiments, the frequency can change from a first frequency to a second frequency, or to additional frequencies. The frequency can change by either scanning or by hopping. Scanning as used herewith means to change values in a consecutive or sequential order, either increasing or decreasing in value using a non-integer method for example the charging of a capacitor where there is a smooth transition from one frequency to another while hitting all the frequencies in between. For example, transitioning gradually from 350 Hz to 400 Hz while hitting all the frequencies in between. Hopping means to change from a first value to a second value in a digital move, where the first value and the second value are incrementally different and may or may not be consecutive. For example, a first value might be 350 Hz, and a second value might be 600 Hz, and a third value might be 400 Hz. Frequency hopping is more likely to be digital and programmed in nature and not relying on a physical process like charging a capacitor. In some embodiments, the light source can be chosen based on the time of day that the system will be used. By way of example, it can be beneficial to use an EL light during night time hours and a LED light during daytime hours. In some embodiments, the light source can also act as the sound generating device.

The electric grid can be made from an electrically conductive material. Suitable materials include stainless steel, silver, copper, gold, aluminum, titanium, similar materials, and combinations thereof. In some embodiments, the material can be 304 or 316 stainless steel. The electrical grid can be mesh cloth. The grid openings of the electrical grid can be any suitable size, including openings between about 0.1 and about 1.0 inches, in some embodiments about 0.25 inches to 0.5 inches. In some embodiments, the grid can be a number 2 grid (i.e. two grids per linear inch), a number 3 grid (i.e. three grids per linear inch), or a number 4 grid (i.e. four grids per linear inch). The size of the grids can be determined based on the size of the insects to be attracted by the system. In some embodiments, more than one grid can be used in the system. The grids can be the same size or different sizes. In some embodiments when more than one grid is used, the grids can be spaced such that the larger grid can be placed in front of the smaller grid (i.e. the larger grid is closer to the opening of the panel). The grids can be sized to allow light and scents to transmit through the grids. A spacer can be used to separate the materials. The spacer between the grids can be between about 0.1 inches and about 2 inches, in some embodiments about 0.25 inches and in some embodiments about 0.50 inches.

The system can further include an attraction sensory panel. The attraction sensory panel can include multiple sensory operations in a single device. The attraction sensory panel can include the light source. The attraction sensory panel can include a pheromone and/or scent. In some embodiments, the attraction sensory panel can further include at least one heater, for example a self-limiting heated strip, and at least one pheromone or scent. In an embodiment of the invention, at least one heater can be located adjacent to the light source. Pheromones or scents within the attraction sensory panel can be replaced as needed, for example on a semiannually or annual basis. The heated strip can be graphite based. Pheromones can be used to attract insects to the system for electrocution. The pheromones or scent can be selected to attract one or more specific insects. More than one pheromone can be used in the system to attract more than one insect. Suitable scents can include, but are not limited to, scents associated with food, including carbon dioxide, reproduction and egg laying, and combinations thereof. Scents that attract egg laying insects can include butyric acid and hexanoic acid. Scent associated with food may include materials found in animal sweat, including nonanal, lactic acid, butyric acid, hexanoic acid and other acids or esters with a molecular weight of less than 120, octanol, and low molecular weight carboxylic acids, and combinations thereof. For scents that mimic food concentrations between about 0.01% and about 30% can be used. Using concentrations from between 0.1% and about 20% to attract insects can be more beneficial. 0.001% and about 5%, with target ranges between 0.01% and about 2% to 0.01% being more beneficial. In some embodiments, a fan can be used to distribute the scent or pheromone. The attraction sensory panel can be polymeric material, for example an acrylic material. In some embodiments, the attraction sensory panel can include a fan and at least one switch for each scent or group of scents to turn additional scents on or off in the panel. Activation of the switch may be controlled by a processor, timer, light sensor or other methods know to those of skill in the art. In some embodiments, the attraction sensory panel can also include a separate power storage device or the battery for the system.

The pheromone and/or scent can be in a polymer matrix, silica gel or activated carbon or another porous carrier. The polymers used can include UV or heat cured polyurethanes, acrylics, and vinyl, inks and combinations thereof. The heater can heat the polymer matrix thereby enhancing the release of the pheromone and/or scent, which can be in the matrix. In some embodiments, multiple pheromones and/or scent can be used which can be activated in the attraction sensory panel at separate times to increase the release of a particular pheromone and/or scent, or simultaneously in the same or different quantities. In some embodiments, a computer program or programmable device can be used to activate or disable the heater. In some embodiments, the program or programmable device can control the heater and/or the pheromone release such that the scent from the pheromones or scents are released during predetermined times or for a predetermined duration. The predetermined time can be for any duration during a day, week, month, or year. The predetermined duration can be for between about 1 minute and about 24 hours. In some embodiments, the predetermined time can be for one hour, two hours, five hours, or ten hours. By way of example only, the attraction sensory panel can include pheromone A and scent B, each within a polymer matrix. The heater associated with pheromone A can be turned on to increase the release of pheromone A. The heater associated with scent B can remain off, thereby increasing the release of pheromone A compared to scent B. Alternatively, both heaters can be activated simultaneously and the temperature varied at each heater to produce a desired mixture of pheromone A and B. In some embodiments, a sonic device can be used to release the pheromones and/or scent by vibration. Suitable devices include, but are not limited to, a sonic with the integrated barium titanate dielectric array, piezoelectric speakers or coil driven speakers, or combinations thereof. The attraction sensory panel can be between about 4 inches and about 12 inches wide and about 6 inches to about 28 inches long, and, between about 0.1 and about 0.5 inches thick, in some embodiments the sensory panel is about 6 inches by about 18 inches about 0.25 inches thick. The attraction sensory panel can be a polymeric material. In some embodiments, the polymeric material can be acrylic composite. Other suitable materials can include polycarbonate or another stiff transparent plastic. In some embodiments, the polymer can by ultraviolet stabilized. These matrixes can be placed on EL lamps or other warming elements where the heat can help to volatilize and transmit these scents into the air.

The attraction sensory panel can be on a fixed panel in the device. In some embodiments, the attraction sensory panel can become the fixed panel once assembled into the operational panel. In some embodiments, the attraction sensory panel can be attached to a fixed panel in the operational panel. By way of example only, the light source and the attraction sensory panel can be on the back side of the system. In these embodiments, the light source and the attraction sensory panel can be oriented in any direction on the fixed panel. The electrical grid can be located in front of the fixed panel. The system can further include a frequency emitting device. The frequency emitting device can be used to produce sounds that can trap insects in the system by disrupting the vibrational communication between insects. The frequency can be between about 100 Hz and about 2000 Hz can be used but a narrow range of about 350 Hz to about 550 Hz can be more focused to get the desired results. Frequency hopping (as described above) can be done at different intervals for example 25 Hz steps for 5 to 600 seconds at each step or the steps can be proportional for example like musical notes from F4 (349.23 Hz) to C#5 (554.37 Hz). In some embodiments, the frequency can change by scanning. The amplitude can vary depending upon the foliage where the system is located. In some embodiments, the sound emitted can be calibrated to the insect to be terminated. The frequency emitting device can be the heated strip, the light source or another device in the system. In some embodiments, the components of the system can oscillate to create the emitting frequency. For example, the inverter of the system can generate a frequency.

The system, or components of the system, can be powered by an energy source. The energy source can be from at least one battery, solar energy, electricity, coal, water power, geothermal, natural gas, oil, or combinations thereof. In some embodiments, the energy source can be used to charge at least one battery associated with the panel for subsequent use.

A solar panel can be used to charge at least one battery for use by the system. The solar panel can have a wattage between about 1 W and about 100 W, in some embodiments about 20 W. The solar panel can produce between about 10 V and about 30 V, in some embodiments about 21 V. The solar panel can also produce between about 0.1 A and about 10 A, in some embodiments about 1 A. The dimensions of the solar panel can be between 6 inches and 36 inches, by between 10 inches and 24 inches, by between 13 inches and 20 inches. In some embodiments, the dimensions of the solar panel can be 20 inches by 13.37 inches by 1.375 inches thick. Suitable solar powered system includes, but are not limited to, systems produced by Infinium Solar, Sun Power, Kyocera, Ameresco Solar and combinations thereof. More than one solar panel can be used to achieve the required power to operate the system. Cables that attach the solar panel to the operation panel can be UV stabilized, and suitable for outdoor use. In some embodiments, the cables can be covered by a material to protect the cable from weather. By way of example only, the cables can be PVC coated copper wires. The wires can be between about 12 and about 24 AWG, in some embodiments about 16 AWG.

The system can include at least one power storage device, such as a battery. Multiple batteries can be joined in series or in parallel. Each battery can be rated for between about 3.7 and 24 V, in some embodiments about 12 V. When the batteries are powered in an inverter, they can create greater than about 2500 V. The inverter voltage may be increased by use of a boost inverter, a buck inverter or a voltage multiplier for example a capacitor and diode bridge. Each battery can be rated for between about 1 and 30 Amp-hours, in some embodiments about 9 Amp-hours. Each battery can operate at a temperature between about −40° C. and about 60° C. The battery can be weatherproof, or located in a weatherproof container. The weight of each battery can be between about 1 lb and about 5 lbs, in some embodiments about 2.8 lbs. The battery can be used to power components in the system, or components of the system, including a microprocessor which can control the light source, a boost inverter, and a voltage multiplier. A boost inverter can be used to convert direct current into alternating current. A boost inverter can build a magnetic field in an inductor, then turned off to stop current flow. A voltage pulse can be generated as the magnetic field collapses. A voltage multiplier can be used to power the electrical grid.

The attraction sensory panel, frequency emitting device, electronic components, power components, and electrical grid can be in an operation panel. In some embodiments, components, for example batteries, and the power supply, can be exterior to the operational panel. The operational panel can be a container, such as a box, that is open on one side. One side of the panel can be the fixed panel. The grids can be positioned over the attraction sensory panel and attach to the side panels of the operational panel. The operational panel can also include a protective panel on the open side of the operational panel over the grids. The protective panel can be sized according to the size of the operational panel. The protective panel can prevent animals, such as birds or humans from contacting the electrical grid. The length of the panel can be between about 6 inches and about 48 inches. The width of the panel can be between about 1 inch and about 12 inches, and the height of the panel can be between about 0.5 inches and about 48 inches. In some embodiments, the length of the panel can be about 18 inches, the width of the panel can be about 4 inches, and the height of a panel can be about 6 inches. Suitable materials for the operational panel can include any non-corrosive material, including but not limited to stainless steel, coated aluminum, titanium, aluminum alloys, and combinations thereof. In some embodiments, the material of the operational panel can be 304 stainless steel.

The system can further comprise a control manager. The control manager of the system can manage the charge control of power from the solar panel to the battery. The control manager can also include a short circuit protection. The short circuit protection can determine if there is a short in the panel, for example, a short caused by weather. If a short has been found, then the short circuit protection can determine if the short has cleared. For example, the short circuit protection can determine if the short has cleared after a time of between 30 seconds and about 5 minutes, in some embodiments about one minute. When the short has cleared, the short circuit protection can turn the panel back to an operational mode. If the short has not cleared, the short circuit protection can put the system into a safe mode (i.e. off), until the short has cleared. If the short has not cleared after between about 12 hours and about 72 hours, in some embodiments about 24 hours, a signal or message can be sent to a user. The control manager can also be used to turn the system to an operational mode. The control manager can compare the battery voltage to the solar panel. When the battery voltage is greater than the solar panel, the panel can turn on (i.e. operational mode). The control manager can also be equipped with a timer that turns the system, or components of the system, on and off as desired. In some embodiments, the operational period can be between about 8-12 hours. In other embodiments, when the battery voltage is less than the solar panel, the panel can turn off. The panel can be operational from dusk for a period of time. The period of time can be between about 8 hours and 12 hours, in some embodiments about 10 hours, in other embodiments longer than 12 hours depending upon power availability.

Components in the system can be monitored remotely. In some embodiments, the control manager panel can also monitor components in the system. A user can be notified, for example, when battery power is low, if the system is not working correctly (for example if there is an issue with a solar panel), if the life of a battery is low, or if the system is not optimally working (for example if the solar panel is not receiving optimal sunlight). Other components can also be monitored and recorded for the user, which can be remotely transmitted to the user. Thus, in some embodiments, the system can include a signal generator.

Advantageously, while power can be drawn to the system during the day with the solar panel, the system can be operational only after dusk. By operating during dark hours of the day, the system cannot and does not attract pollinating insects that are active during the light hours of the day. Rather, the operation of the insect attracting elements are configured to not attract pollinating insects. Instead, the system can be used at that time period to attract insects that are harmful to agriculture and humans. These insects can be selected from the group consisting of an insect from a subject/order selected from the group consisting of mitsubishi, orthopteran, homopterous, rhynogta, coleopteran, lepidoptera, hymenoptera, diptera, and combinations thereof. Specific insects include termites, crickets, slugs, locusts, leaf hoppers, bugs, moths, chafers, scarabs, worms, longicorns, weevils, mosquitos, maggots, cockroaches, house flies, wasps, buzzers, green leafhoppers, migratory locusts, slugs, green leafhoppers, tettigonlidaes, northern china crickets, house termites, a Huainan local termites, black wing local termites, green mirid bugs, banana lace bugs, ping stinkbugs, changes stinkbugs, strip bee green stinkbugs, velvety chafers, verdigris scarabs, apple gooding worms, mulberry longicorns, spotted cerabycids, black sani tortoises, white spotted flower chafers, codling moths, a. transitella—navel orangewood worms, corn ear worm moths, green scaly weevils, grape horn worms, cacaecia crateagans, copper geometrides, twill leaf miners, bore fruit moths, cut worms, pine caterpillars, navicular caterpillars, persimmon fruit worms, oriental moths, grape said encleiades, locusts, plow solid bees, plow stem buzzers, wasps, peach wasps, mosquitoes, yellow fever mosquitos, zika carrying mosquitoes, dengue carrying mosquitoes, lutzomyia corn seed maggots, orange euribiidaes, and combinations thereof.

The system can be mounted using any suitable device or tool. By way of example, the system can be mounted on a pole or on the side of a building. A framed hanger can be used to mount the system. Furthermore, multiple operational panels can be combined to form a system.

The present disclosure is directed to a method to manufacture an insect control device.

A light source can be included in the insect control device. The light source can be mechanically mounted or bonded with an adhesive to a substrate. The light source can emit light in a wavelength between 250 nm and 650 nm. The light source can be fluorescent, luminescent light, or a LED, including an OLED, and combinations thereof. In some embodiments, multiple light sources can be used, which can emit the same or different wavelengths of light. Different wavelengths can be more or less attractive to insects. The light source can be emitted as at least one spot, dot, strip, panel, triangle, oval, rectangle or any other suitable and/or desired shape. The light source can also be a plurality of light sources or can emit at least two wavelengths of light. The light can be from a Lambertian emitter. The lights can emit light at wavelengths between about 250 nm and about 800 nm, in some embodiments about 300 to 650 nanometer, in some embodiments between 350 to 480 nanometers. In some embodiments, the light source can be an electroluminescent light that can be blue in color and in the range of 400 nm to 480 nm. In some embodiments, the light source can be a LED light, which can be green in color and about 525 nm. In some embodiments, the light source (electroluminescent or otherwise) can pulse. In embodiments where multiple light sources are used, each light source can pulse at the same frequency or at different frequencies. The frequency of the pulse can be between about 100 Hz and about 2000 Hz. In some embodiments, the frequency of the pulse can be between about 100 Hz and about 600 Hz, about 350 Hz to about 550 Hz, about 100 Hz to about 1000 Hz, or between about 100 Hz and about 1500 Hz. In some embodiments, the frequency can change from a first frequency to a second frequency, or to additional frequencies. The frequency can change by either scanning or by hopping. Scanning as used herewith means to change values in a consecutive or sequential order, either increasing or decreasing in value using a non-integer method for example the charging of a capacitor where there is a smooth transition from one frequency to another while hitting all the frequencies in between. For example, transitioning gradually from 350 Hz to 400 Hz while hitting all the frequencies in between. Hopping means to change from a first value to a second value in a digital move, where the first value and the second value are incrementally different and may or may not be consecutive. For example, a first value might be 350 Hz, and a second value might be 600 Hz, and a third value might be 400 Hz. Frequency hopping is more likely to be digital and programmed in nature and not relying on a physical process like charging a capacitor. In some embodiments, the light source can be chosen based on the time of day that the system will be used. By way of example, it can be beneficial to use an EL light during night time hours and a LED light during daytime hours. In some embodiments, the light source can also act as the sound generating device.

The electric grid can be made from an electrically conductive material. Suitable materials include stainless steel, silver, copper, gold, aluminum, titanium, similar materials, and combinations thereof. In some embodiments, the material can be 304 or 316 stainless steel. The electrical grid can be mesh cloth. The grid openings of the electrical grid can be any suitable size, including openings between about 0.1 and about 1.0 inches, in some embodiments about 0.25 inches to 0.5 inches. In some embodiments, the grid can be a number 2 grid (i.e. two grids per linear inch), a number 3 grid (i.e. three grids per linear inch), or a number 4 grid (i.e. four grids per linear inch). The size of the grids can be determined based on the size of the insects to be attracted by the system. In some embodiments, more than one grid can be used in the system. The grids can be the same size or different sizes. In some embodiments when more than one grid is used, the grids can be spaced such that the larger grid can be placed in front of the smaller grid (i.e. the larger grid is closer to the opening of the panel). The grids can be sized to allow light and scents to transmit through the grids. A spacer can be used to separate the materials. The spacer between the grids can be between about 0.1 inches and about 2 inches, in some embodiments about 0.25 inches and in some embodiments about 0.50 inches. The grid can be mechanically mounted to an operational panel or box.

The system can further include an attraction sensory panel. The attraction sensory panel can include multiple sensory operations in a single device. The attraction sensory panel can include the light source. The attraction sensory panel can include a pheromone and/or scent. In some embodiments, the attraction sensory panel can further include at least one heater, for example a self-limiting heated strip, and at least one pheromone or scent. In an embodiment of the invention, at least one heater can be located adjacent to the light source. Pheromones or scents within the attraction sensory panel can be replaced as needed, for example on a semiannually or annual basis. The heated strip can be graphite based. Pheromones can be used to attract insects to the system for electrocution. The pheromones or scent can be selected to attract one or more specific insects. More than one pheromone can be used in the system to attract more than one insect. Suitable scents can include, but are not limited to, scents associated with food, including carbon dioxide, reproduction and egg laying, and combinations thereof. Scents that attract egg laying insects can include butyric acid and hexanoic acid. Scent associated with food may include materials found in animal sweat, including nonanal, lactic acid, butyric acid, hexanoic acid and other acids or esters with a molecular weight of less than 120, octanol, and low molecular weight carboxylic acids, and combinations thereof. For scents that mimic food concentrations between about 0.01% and about 30% can be used. Using concentrations from between 0.1% and about 20% to attract insects can be more beneficial. 0.001% and about 5%, with target ranges between 0.01% and about 2% to 0.01% being more beneficial. In some embodiments, a fan can be used to distribute the scent or pheromone. The attraction sensory panel can be polymeric material, for example an acrylic material. In some embodiments, the attraction sensory panel can include a fan and at least one switch for each scent or group of scents to turn additional scents on or off in the panel. Activation of the switch may be controlled by a processor, timer, light sensor or other methods know to those of skill in the art. In some embodiments, the attraction sensory panel can also include a separate power storage device or the battery for the system.

The attraction sensory panel can include between about 6 and about 30 layers of screen printed inks. The layers can be deposited onto a substrate. The finished attraction sensory panels can be laser cut with the substrate and affixed to a clear panel made of acrylic. An adhesive can be used to affix the panel to the substrate. The adhesive can be an acrylate polymer, for example 3M 467 adhesive. The spacer can be a polymeric material, for example an acrylic, polyethylene, or polyethylene terephthalate spacer, or other transparent or translucent material. A cover sheet can also be used to finish the box and protect the edges of the screen. Suitable cover sheet materials include, polyethylene terephthalate, polyethylene, polypropylene or other opaque, transparent or translucent material that is not conductive and combinations thereof. Parts can be held together using rivets, which can be polymeric and non-conductive, for example a plastic rivet, such as Klick-loc 5 mm plastic rivets.

The pheromone and/or scent can be in a polymer matrix, silica gel or activated carbon or another porous carrier. The polymers used can include UV or heat cured polyurethanes, acrylics, and vinyl, inks and combinations thereof. The heater can heat the polymer matrix thereby enhancing the release of the pheromone and/or scent, which can be in the matrix. In some embodiments, multiple pheromones and/or scent can be used which can be activated in the attraction sensory panel at separate times to increase the release of a particular pheromone and/or scent, or simultaneously in the same or different quantities. In some embodiments, a computer program or programmable device can be used to activate or disable the heater. In some embodiments, the program or programmable device can control the heater and/or the pheromone release such that the scent from the pheromones or scents are released during predetermined times or for a predetermined duration. The predetermined time can be for any duration during a day, week, month, or year. The predetermined duration can be for between about 1 minute and about 24 hours. In some embodiments, the predetermined time can be for one hour, two hours, five hours, or ten hours. By way of example only, the attraction sensory panel can include pheromone A and scent B, each within a polymer matrix. The heater associated with pheromone A can be turned on to increase the release of pheromone A. The heater associated with scent B can remain off, thereby increasing the release of pheromone A compared to scent B. Alternatively, both heaters can be activated simultaneously and the temperature varied at each heater to produce a desired mixture of pheromone A and B. In some embodiments, a sonic device can be used to release the pheromones and/or scent by vibration. Suitable devices include, but are not limited to, a sonic with the integrated barium titanate dielectric array, piezoelectric speakers or coil driven speakers, or combinations thereof. The attraction sensory panel can be between about 4 inches and about 12 inches wide and about 6 inches to about 28 inches long, and, between about 0.1 and about 0.5 inches thick, in some embodiments the sensory panel is about 6 inches by about 18 inches about 0.25 inches thick. The attraction sensory panel can be a polymeric material. In some embodiments, the polymeric material can be acrylic composite. Other suitable materials can include polycarbonate or another stiff transparent plastic. In some embodiments, the polymer can by ultraviolet stabilized. These matrixes can be placed on EL lamps or other warming elements where the heat can help to volatilize and transmit these scents into the air.

The attraction sensory panel can be mechanically mounted or bonded to a fixed panel in the device. In some embodiments, the attraction sensory panel can become the fixed panel once assembled into the operational panel. In some embodiments, the attraction sensory panel can be attached to a fixed panel in the operational panel. By way of example only, the light source and the attraction sensory panel can be on the back side of the system. In these embodiments, the light source and the attraction sensory panel can be oriented in any direction on the fixed panel. The electrical grid can be located in front of the fixed panel. The system can further include a frequency emitting device. The frequency emitting device can be used to produce sounds that can trap insects in the system by disrupting the vibrational communication between insects. The frequency can be between about 100 Hz and about 2000 Hz can be used but a narrow range of about 350 Hz to about 550 Hz can be more focused to get the desired results. Frequency hopping (as described above) can be done at different intervals for example 25 Hz steps for 5 to 600 seconds at each step or the steps can be proportional for example like musical notes from F4 (349.23 Hz) to C#5 (554.37 Hz). In some embodiments, the frequency can change by scanning. The amplitude can vary depending upon the foliage where the system is located. In some embodiments, the sound emitted can be calibrated to the insect to be terminated. The frequency emitting device can be the heated strip, the light source or another device in the system. In some embodiments, the components of the system can oscillate to create the emitting frequency. For example, the inverter of the system can generate a frequency.

The system, or components of the system, can be powered by an energy source. The energy source can be from at least one battery, solar energy, electricity, coal, water power, geothermal, natural gas, oil, or combinations thereof. In some embodiments, the energy source can be used to charge at least one battery associated with the panel for subsequent use.

A solar panel can be used to charge at least one battery for use by the system. The solar panel can have a wattage between about 1 W and about 100 W, in some embodiments about 20 W. The solar panel can produce between about 10 V and about 30 V, in some embodiments about 21 V. The solar panel can also produce between about 0.1 A and about 10 A, in some embodiments about 1 A. The dimensions of the solar panel can be between 6 inches and 36 inches, by between 10 inches and 24 inches, by between 13 inches and 20 inches. In some embodiments, the dimensions of the solar panel can be 20 inches by 13.37 inches by 1.375 inches thick. Suitable solar powered system includes, but are not limited to, systems produced by Infinium Solar, Sun Power, Kyocera, Ameresco Solar and combinations thereof. More than one solar panel can be used to achieve the required power to operate the system. Cables that attach the solar panel to the operation panel can be UV stabilized, and suitable for outdoor use. In some embodiments, the cables can be covered by a material to protect the cable from weather. By way of example only, the cables can be PVC coated copper wires. The wires can be between about 12 and about 24 AWG, in some embodiments about 16 AWG.

The system can include at least one power storage device, such as a battery. Multiple batteries can be joined in series or in parallel. Each battery can be rated for between about 3.7 and 24 V, in some embodiments about 12 V. When the batteries are powered in an inverter, they can create greater than about 2500 V. The inverter voltage may be increased by use of a boost inverter, a buck inverter or a voltage multiplier for example a capacitor and diode bridge. Each battery can be rated for between about 1 and 30 Amp-hours, in some embodiments about 9 Amp-hours. Each battery can operate at a temperature between about −40° C. and about 60° C. The battery can be weatherproof, or located in a weatherproof container. The weight of each battery can be between about 1 lb and about 5 lbs, in some embodiments about 2.8 lbs. The battery can be used to power components in the system, or components of the system, including a microprocessor which can control the light source, a boost inverter, and a voltage multiplier. A boost inverter can be used to convert direct current into alternating current. A boost inverter can build a magnetic field in an inductor, then turned off to stop current flow. A voltage pulse can be generated as the magnetic field collapses. A voltage multiplier can be used to power the electrical grid.

The attraction sensory panel, frequency emitting device, electronic components, power components, and electrical grid can be in an operation panel. In some embodiments, components, for example batteries, and the power supply, can be exterior to the operational panel. The operational panel can be a container, such as a box, that is open on one side. One side of the panel can be the fixed panel. The grids can be positioned over the attraction sensory panel and attach to the side panels of the operational panel. The operational panel can also include a protective panel on the open side of the operational panel over the grids. The protective panel can be sized according to the size of the operational panel. The protective panel can prevent animals, such as birds or humans from contacting the electrical grid. The length of the panel can be between about 6 inches and about 48 inches. The width of the panel can be between about 1 inch and about 12 inches, and the height of the panel can be between about 0.5 inches and about 48 inches. In some embodiments, the length of the panel can be about 18 inches, the width of the panel can be about 4 inches, and the height of a panel can be about 6 inches. Suitable materials for the operational panel can include any non-corrosive material, including but not limited to stainless steel, coated aluminum, titanium, aluminum alloys, and combinations thereof. In some embodiments, the material of the operational panel can be 304 stainless steel.

The system can further comprise a control manager. The control manager of the system can manage the charge control of power from the solar panel to the battery. The control manager can also include a short circuit protection. The short circuit protection can determine if there is a short in the panel, for example, a short caused by weather. If a short has been found, then the short circuit protection can determine if the short has cleared. For example, the short circuit protection can determine if the short has cleared after a time of between 30 seconds and about 5 minutes, in some embodiments about one minute. When the short has cleared, the short circuit protection can turn the panel back to an operational mode. If the short has not cleared, the short circuit protection can put the system into a safe mode (i.e. off), until the short has cleared. If the short has not cleared after between about 12 hours and about 72 hours, in some embodiments about 24 hours, a signal or message can be sent to a user. The control manager can also be used to turn the system to an operational mode. The control manager can compare the battery voltage to the solar panel. When the battery voltage is greater than the solar panel, the panel can turn on (i.e. operational mode). The control manager can also be equipped with a timer that turns the system, or components of the system, on and off as desired. In some embodiments, the operational period can be between about 8-12 hours. In other embodiments, when the battery voltage is less than the solar panel, the panel can turn off. The panel can be operational from dusk for a period of time. The period of time can be between about 8 hours and 12 hours, in some embodiments about 10 hours, in other embodiments longer than 12 hours depending upon power availability.

Components in the system can be monitored remotely. In some embodiments, the control manager panel can also monitor components in the system. A user can be notified, for example, when battery power is low, if the system is not working correctly (for example if there is an issue with a solar panel), if the life of a battery is low, or if the system is not optimally working (for example if the solar panel is not receiving optimal sunlight). Other components can also be monitored and recorded for the user, which can be remotely transmitted to the user. Thus, in some embodiments, the system can include a signal generator.

Advantageously, while power can be drawn to the system during the day with the solar panel, the system can be operational only after dusk. By operating during dark hours of the day, the system cannot and does not attract pollinating insects that are active during the light hours of the day. Rather, the operation of the insect attracting elements are configured to not attract pollinating insects. Instead, the system can be used at that time period to attract insects that are harmful to agriculture and humans. These insects can be selected from the group consisting of an insect from a subject/order selected from the group consisting of mitsubishi, orthopteran, homopterous, rhynogta, coleopteran, lepidoptera, hymenoptera, diptera, and combinations thereof. Specific insects include termites, crickets, slugs, locusts, leaf hoppers, bugs, moths, chafers, scarabs, worms, longicorns, weevils, mosquitos, maggots, cockroaches, house flies, wasps, buzzers, green leafhoppers, migratory locusts, slugs, green leafhoppers, tettigonlidaes, northern china crickets, house termites, a Huainan local termites, black wing local termites, green mirid bugs, banana lace bugs, ping stinkbugs, changes stinkbugs, strip bee green stinkbugs, velvety chafers, verdigris scarabs, apple gooding worms, mulberry longicorns, spotted cerabycids, black sani tortoises, white spotted flower chafers, codling moths, a. transitella—navel orangewood worms, corn ear worm moths, green scaly weevils, grape horn worms, cacaecia crateagans, copper geometrides, twill leaf miners, bore fruit moths, cut worms, pine caterpillars, navicular caterpillars, persimmon fruit worms, oriental moths, grape said encleiades, locusts, plow solid bees, plow stem buzzers, wasps, peach wasps, mosquitoes, yellow fever mosquitos, zika carrying mosquitoes, dengue carrying mosquitoes, lutzomyia corn seed maggots, orange euribiidaes, and combinations thereof.

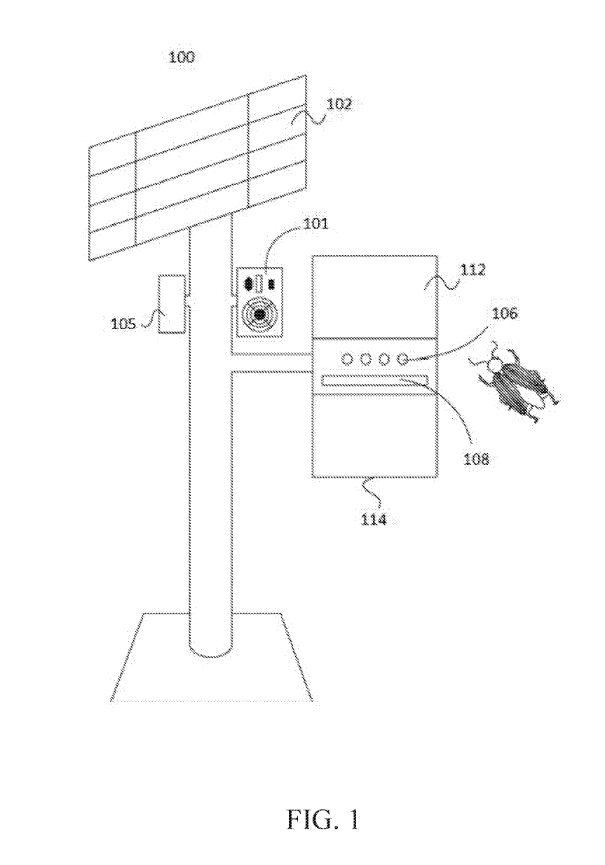

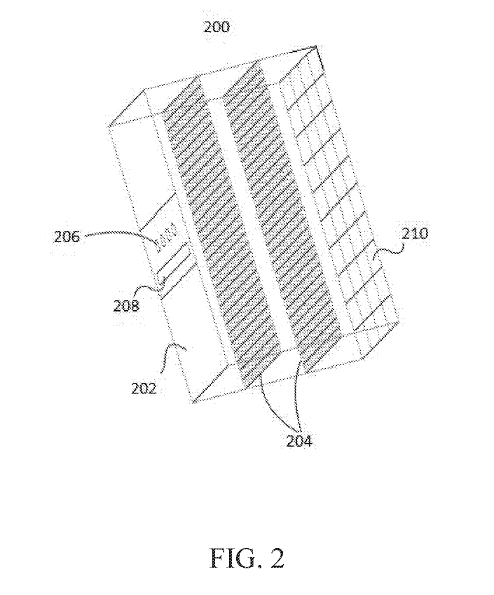

The system can be mounted using any suitable device or tool. By way of example, the system can be mounted on a pole or on the side of a building. A framed hanger can be used to mount the system. Furthermore, multiple operational panels can be combined to form a system. FIG. 1 illustrates a manner in which the present invention can function to lure and terminate pest insects. The present invention can be a system 100 that includes a solar panel 102 (i.e. photovoltaic panel). The solar panel 102 can collect energy that can be stored in a battery 105. While a single battery is illustrated in FIG. 1, one skilled in the art would understand that multiple batteries can be used for storage of energy without deviating from the invention. A charge controller can be used to protect the batteries from over charging. The battery 104 can be used in conjunction with an inverter to provide the AC power needed to drive the operation panel. The battery can also power a power supply 101. The battery 104 can also work to power a heated strip 108, spot LEDs 106, and provide power for the electrified grid (illustrated in FIG. 2). The heated strip 108 can increase the vapor pressure of the pheromones and increase the distance of pheromone spread to attract insects. The number of spot LEDs 106 can vary without deviating from the invention. The spot LEDs 106 can be selected for any wavelength to act as an attractant. Typically, this wavelength can be shorter than about 420 nm. The spot LEDs 106 and a light source 112, which can be a EL lamp, can flash at a rate that affects insects, but not to humans. The light source 112, the spot LEDs 106, the heated strip 108 can be housed in an operational power 114.

FIG. 2 illustrates an operation panel 200 according to aspects of the present disclosure. The attraction sensory panel 202 can include the light source 206 with the option for a heated strip 208 to release pheromones. While FIG. 2 illustrates the attraction sensory panel 200 as being along the width of the operational panel 200, one skilled in the art would understand that the attraction sensory panel 202 could be lengthwise along the operational panel 200 without deviating from the invention. The attraction sensory panel 202 illustrates the light source 206 as three spot LEDs (though any number of light sources can be used) to attract insects. Insects are attracted quickly at a shorter range, and longer for longer range. In front of the attraction sensory panel 202 can be at least one electrified grid 204. In some embodiments, as illustrated in FIG. 2, two electrified grids 204 can be used that function as a zapper to eliminate insects as they contact the operational panel 200. The electrocuted insects can be discarded through openings in the operational panel 200 (not illustrated). The operational panel 200 can also include a protective panel 210 to prevent people or large animals, birds, or humans from harm. The two electrified grids 204 can be set apart from one another by a small distance, in order for the bug to complete the circuit as it touches both screens, thus eradicating the pest. According to aspects of the present disclosure, in at least some embodiments the separation may be on the order of 0.05 inches to about 0.75 inches.

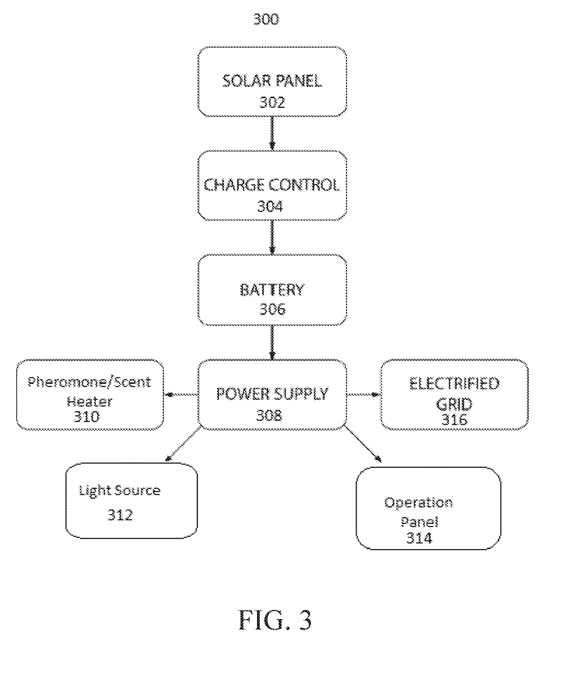

FIG. 3 is a diagram 300 of the major electrical and control components in the electroluminescent device according to aspects of the present disclosure. The solar panel 302 can collect energy that can be limited by a charge controller 304. This charge controller 304 can limit power from the solar panel 302 from overcharging and damaging the battery 306. This energy can then be stored in the battery 306 which feeds energy into the power supply 308. This power supply 308 can provide the correct output voltages and frequencies for the light source 312 (including spot LEDs), the operational panel 314, heated pheromone strip 310, and the electrical grid 316.

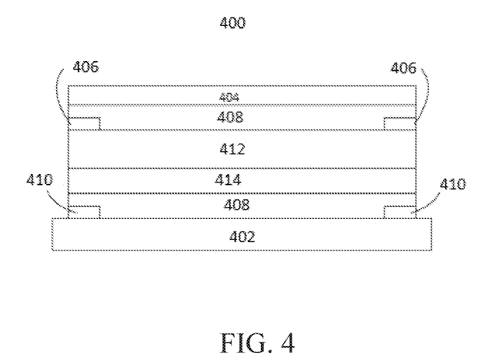

FIG. 4 illustrates the layers contained within the printed EL lamp 400 according to aspects of the present disclosure. The printed EL lamp can be printed with a traditional screen printing process. The substrate 402 can be any suitable material, including plastics and textiles. The ability to vary the substrate 402 offers flexibility to the entire printed lamp. A sealant layer 404 can also be applied to the substrate 402 if desired. Suitable sealant layer 404 materials include, but are not limited to, polymers that are screen printed as a liquid, then undergo free radical polymerization when exposed to UV light. The sealant layer 404 can be between about 50 microns to about 150 microns thick, in some embodiments about 100 microns thick. Furthermore, the sealant can also be used on the sides of the EL lamp down to the substrate 402. At least one front electrode 406 can be included in a clear conductor layer 408. The electrode can be any suitable conductive material. The EL lamp 400 can also include at least one rear electrode 410 and a clear conductor layer 408. By way of example only, the front or rear electrodes 406/408 can be made with silver flake used in the buss bars. The clear conductor layer 408 can be any suitable material, including poly(3.4-ethylenedioxythiophene) polystyrene sulfonate. The front and rear electrodes 406/408 can energize the phosphor layer 412 and dielectric layer 414 when power is supplied to the power supply. The phosphor layer 412 and dielectric layer 414 can act as a capacitor dielectric by turning the changing electric field to light. The dielectric layer 414 can be emphasized to increase the sound output as the energized electrodes produce vibrational responses in the dielectric layer 414. The dielectric layer 414 can contain high dielectric constant compounds bound (which can include a barium titanate or barium/strontium titanate material) into a polymer matrix (where polyurethane or similar material can be a binder for the matrix). The sealant layer and the substrate layer can protect the lamp from shorting, adversely affecting the environmental conditions. FIG. 4 illustrates the sealant layer covering the top clear conductive layer of the EL lamp. In practice, the sealant can also cover the sides of the EL lamp.

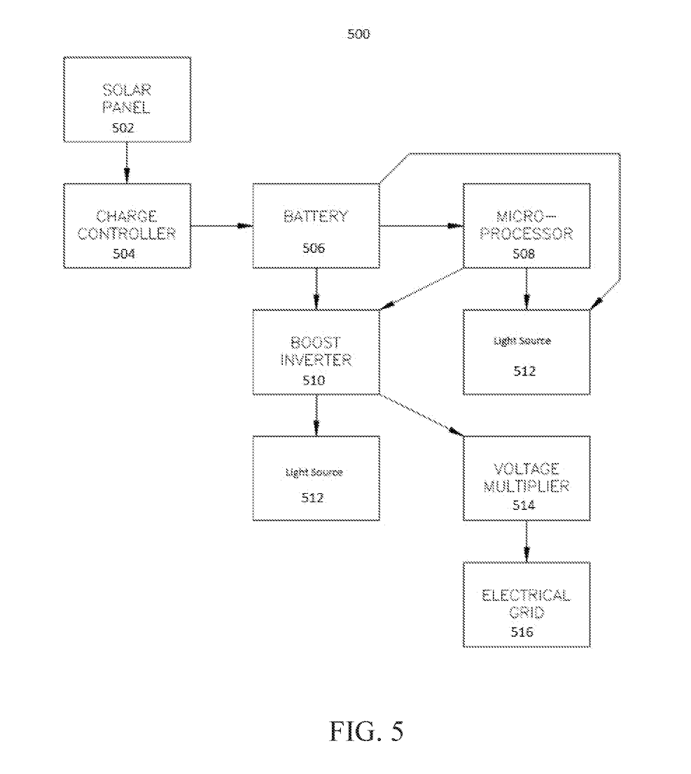

FIG. 5 illustrates an embodiment of the electronics 500 of the insect control device according to aspects of the present disclosure. The electronics include a solar panel 502 which can be connected to a battery 506 (or batteries) through a charge controller 504. The charge controller 504 can control the charged level of the battery so that the battery is not overcharged. The battery 506 can be connected to a microprocessor 508, which can power and control a boost inverter 510, and a light source 512. The battery 506 can also be directly connected to a light source 512. The boost inverter 510 can be powered by the battery 506 and used to power a light source 512 and a voltage multiplier 514. The boost inverter 510 can determine if there is a short in the system and turn the system off if necessary. The voltage multiplier 514 can be used to power the electrical grid 516. In some embodiments, the battery 506 can directly power the electrical grid 516.

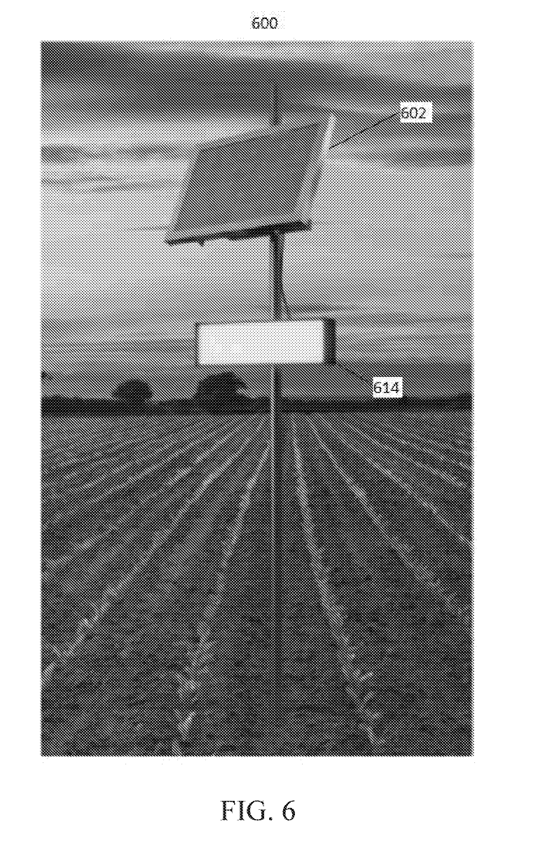

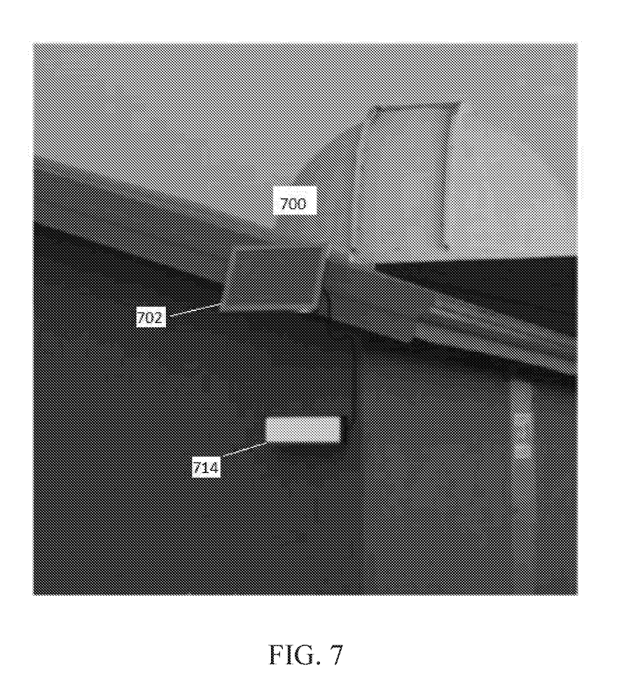

FIG. 6 depicts an embodiment of the present invention in an agricultural field. As illustrated, the system is mounted to a pole in the field. The system 600 includes a solar panel 602, and the operational panel 614 comprising a light source and an electrical grid. A pheromone or scent source can also be included in the system. FIG. 7 depicts an embodiment of the present invention mounted to a building. The system 700 includes a solar panel, and the panel comprising a light source and an electrical grid. A pheromone or scent source can also be included in the system.

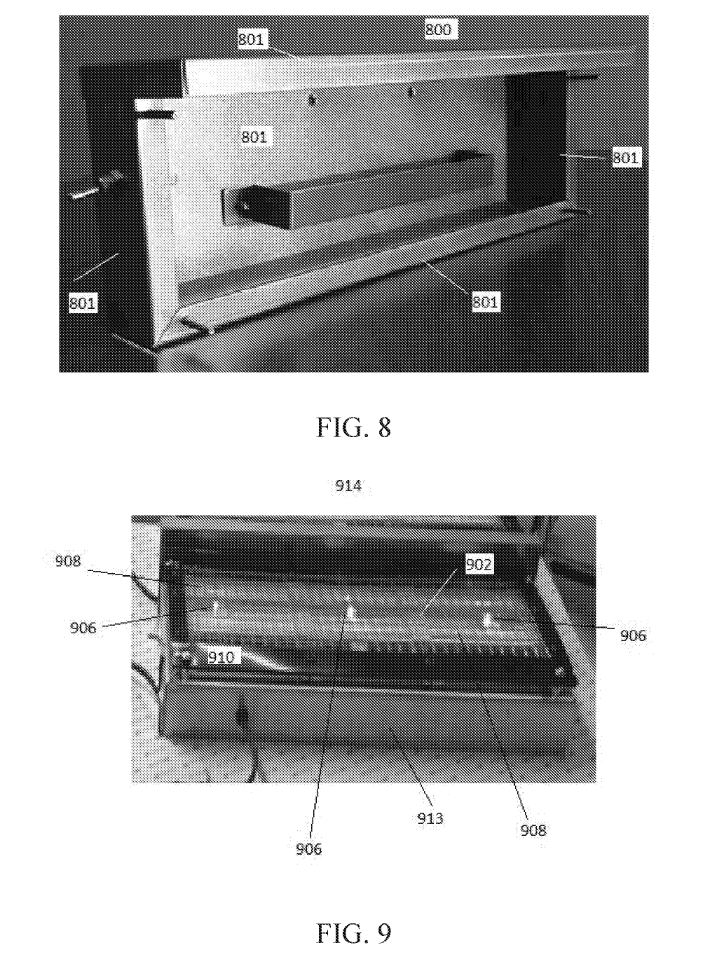

FIG. 8 illustrates an embodiment of a box 800 before components are added to the box. Five sides 801 comprise the box leaving one side open to receive the operative components, including the attraction sensory panel. FIG. 9 illustrates an embodiment of a fully assembled operational panel 914 with the attraction sensory panel 902, including the three light sources 906 and two pheromone/food scent stripes 908 on each side of the light sources 906. A protective panel 910 is also illustrated in FIG. 9.

Ranges have been discussed and used within the forgoing description. One skilled in the art would understand that any sub-range within the stated range would be suitable, as would any number within the broad range, without deviating from the invention.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. An insect control system, comprising:
a light emitting capacitor that acts as a Lambertian emitter;
at least one electrical grid, located within an operation panel; and
a sound generating device, wherein a frequency emitted by the sound generating device hops between different frequencies during operation.

2. The system of claim 1, further comprising at least one light source in addition to the light emitting capacitor, wherein a wavelength of the at least one light source can differ from a wavelength associated with the light emitting capacitor that acts as the Lambertian emitter.

3. The system of claim 1, further comprising a heater and at least one of insect pheromone scent or food scent, and wherein the heater is programmable to heat and release the scent during predetermined times.

4. The system of claim 3, wherein the at least one of a pheromone scent or food scent is selected from the group comprising lactic acid, butyric acid, hexanoic acid, acids or esters with a molecular weight of less than 120.

5. The system of claim 3, further comprising a fan configured to distribute the scent.

6. The system of claim 1, wherein the electroluminescent light source pulses with a frequency between about 100 Hz and about 2000 Hz.

7. The system of claim 1, wherein the time between each frequency interval hop varies.

8. The system of claim 1, wherein the sound generating device emits a frequency of between about 100 Hz and about 2000 HZ.

9. The system of claim 1, wherein the sound generating device emits a frequency between about 350 Hz and about 600 Hz.

10. The system of claim 1, wherein the change of frequency of the hopping frequencies changes between successive intervals.

11. An insect electrocution system, comprising
a solar panel;
at least one power storage device, wherein the power storage device stores energy from the solar panel;
at least one of an electrocution grid or insect trap; and
an operational panel, wherein the operational panel comprises at least two of the following insect attracting elements:
a first light emitting capacitor that is a Lambertian emitter;
a point light source that operates at a different wavelength than the first electroluminescent light source;
at least one of the first light emitting capacitor and the point light source pulses;
at least one sound source, wherein the at least one sound source operates between 100 Hz and 2000 Hz;
at least one scent source; and
wherein the at least one power storage device provides power for the at least two attracting systems, and the at least one electrocution grid.

12. The system of claim 11, wherein the first light emitting capacitor that supplies at least one light at a wavelength of between about 300 nm and about 600 nm.

13. The system of claim 11, wherein the pulse of the at least one of the first light emitting capacitor and the point light source is at a frequency of between about 100 Hz and about 600 Hz.

14. (canceled)

15. The system of claim 11, wherein the operational panel comprises the first light emitting capacitor and the point light source operates at different wavelengths.

16. The system of claim 15, wherein the first light emitting capacitor and the point light source operate at different wavelengths in the range of 300 nm to 600 nm.

17. The system of claim 11 wherein a frequency emitted by the sound generating source hops during operation between different frequencies.

18. The system of claim 11, wherein the operational panel further comprises a sensor that controls the activation and deactivation of the at least two insect attracting elements.

19. The system of claim 11, wherein the operation of the insect attracting elements are configured to not attract pollinating insects.

20. (canceled)

21. The system of claim 13, wherein the time between each light pulse hops between 5 and 600 seconds.

22. The system of claim 11, wherein the wavelength of at least one of the first light emitting capacitor and the point light source hops between different wavelengths.
